(19) United States
(12) Patent Application Publication
(10) Pub. No.: US 2022/0012365 A1
(43) Pub. Date: Jan. 13, 2022

(54) SYSTEM AND METHOD FOR DIFFERENTIATED PRIVACY MANAGEMENT OF USER CONTENT

(71) Applicant: Avast Software s.r.o., Praha 4 (CZ)

(72) Inventors: Deepali Garg, San Jose, CA (US); Rajarshi Gupta, Los Altos, CA (US)

(73) Assignee: Avast Software s.r.o., Praha 4 (CZ)

(21) Appl. No.: 16/926,645

(22) Filed: Jul. 11, 2020

(51) Int. Cl. G06F 21/62; G06K 9/00; G06K 9/66; G06F 16/56; G06N 3/04; G06N 3/08; G06N 20/10

(52) U.S. Cl. CPC G06F 21/6263; G06K 9/00536; G06K 9/66; G06N 20/10; G06N 3/04; G06N 3/08; G06F 16/56

(57) ABSTRACT

A method for applying electronic data sharing settings. The method includes determining a first image or a first plurality of images shared by a user to a first network-enabled application. A first plurality of image components are extracted from the first image or the first plurality of images, and access by the first network-enabled application to a second image or a second plurality of images stored on a computing device of the user is enabled based on the first plurality of image components extracted from the first image or the first plurality of images. A method for controlling internet browsing is further provided.

### FIELD OF INVENTION

The invention relates generally to computing device privacy protocols, and more particularly to access by applications to user data.

### BACKGROUND

Computing devices such as smartphones, laptop and tablet computers, and other personal computing devices execute a variety of applications to perform a variety of functions. To enable full functionality, many applications require access to photographs or other data stored on a user's computing device. Typically access to a particular type of data can be entirely allowed or entirely disallowed by the operating system of the computing device. For example, an application can be granted access to all of the photographs stored by the user on their computing device or none of the photographs on their computing device.

### SUMMARY

This Summary introduces simplified concepts that are further described below in the Detailed Description of Illustrative Embodiments. This Summary is not intended to identify key features or essential features of the claimed subject matter and is not intended to be used to limit the scope of the claimed subject matter.

A method is provided for applying electronic data sharing settings. The method includes determining a first image or a first plurality of images shared by a user to a first network-enabled application. A first plurality of image components are extracted from the first image or the first plurality of images, and access by the first network-enabled application to a second image or a second plurality of images stored on a computing device of the user is enabled based on the first plurality of image components extracted from the first image or the first plurality of images.

A further method for controlling electronic data sharing is provided. The further method includes determining a first plurality of images stored by a user on a computing device, and extracting a first plurality of image components from the first plurality of images. A facial recognition algorithm is applied to one or both of the first plurality of images or the first plurality of image components to determine a first plurality of occurrences of a particular human in the first plurality of images, and access by a first network-enabled application to the first plurality of images stored by the user on the computing device is enabled based on the first plurality of image components and the first plurality of occurrences of the particular human in the first plurality of images.

Another further method for controlling electronic data sharing including determining a first electronic record or a first plurality of electronic records shared by a user to a first network-enabled application, and extracting a first topic or a first plurality of topics from the first electronic record or the first plurality of electronic records. Access by the first network-enabled application to a second electronic record or a second plurality of electronic records on a computing device of the user is enabled based on the first topic extracted from the first electronic record or the first plurality of electronic records.

An internet browsing control method is provided including monitoring a first plurality of network destinations accessed by a user via a computing device via a first browser application, and extracting a first topic or a first plurality of topics from the first plurality of network destinations. An attempt to access a particular network destination by the user via the computing device via the first browser application is determined, and access by the user to the particular network destination via the computing device via the first browser application based on the first topic or the first plurality of topics and based on the particular network destination is disabled.

### BRIEF DESCRIPTION OF THE DRAWING(S)

A more detailed understanding may be had from the following description, given by way of example with the accompanying drawings. The Figures in the drawings and the detailed description are examples. The Figures and the detailed description are not to be considered limiting and other examples are possible. Like reference numerals in the Figures indicate like elements wherein:

FIG. 1 shows a system for managing access by applications to stored user content and controlling internet browser use.

FIG. 2 shows an exemplary photo classification graph for aiding in the understanding of described methods.

FIGS. 3A-3C are diagrams illustrating process flows used in inferring photo sharing policies and training corresponding classifiers.

FIG. 4 is a diagram showing figuratively an image classifier in the form of a convolutional neural network (“CNN”) for extracting image components of a photo.

FIG. 5 is a diagram showing figuratively a photo sharing classifier in the form of a support vector machine (“SVM”) classifier.

FIG. 6A is a diagram figuratively showing a classifier in the form of a recurrent neural network (“RNN”) for identifying topics described in a contact record.

FIG. 6B is a diagram figuratively showing an example implementation of the classifier of FIG. 6A.

FIG. 7 is a diagram showing figuratively a contact sharing classifier in the form of a support vector machine (“SVM”) classifier.

FIG. 8A is a diagram figuratively showing a classifier in the form of a recurrent neural network (“RNN”) for identifying topics described in a document record.

FIG. 8B is a diagram figuratively showing an example implementation of the classifier of FIG. 8A.

FIG. 9 is a diagram showing figuratively a document sharing classifier in the form of a support vector machine (“SVM”) classifier.

FIG. 10A is a diagram figuratively showing a classifier in the form of a recurrent neural network (“RNN”) for identifying network usage.

FIG. 10B is a diagram figuratively showing an example implementation of the classifier of FIG. 10A.

FIG. 11 is a diagram showing figuratively a browser use classifier in the form of a support vector machine (“SVM”) classifier.

FIGS. 12A-12D show example interactive displays for querying and receiving query responses from a user according to the illustrative embodiments.

FIGS. 13A, 13B, 14A, 14B, 15A, and 15B are diagrams showing methods for controlling electronic data sharing.

FIGS. 16A and 16B are diagrams showing methods for internet browsing control.

FIG. 17 is an illustrative computer system for performing described methods according to the illustrative embodiments.

### DETAILED DESCRIPTION OF ILLUSTRATIVE EMBODIMENT(S)

Embodiments of the invention are described below with reference to the drawing figures wherein like numerals represent like elements throughout. The terms “a” and “an” as used herein do not denote a limitation of quantity, but rather denote the presence of at least one of the referenced items.

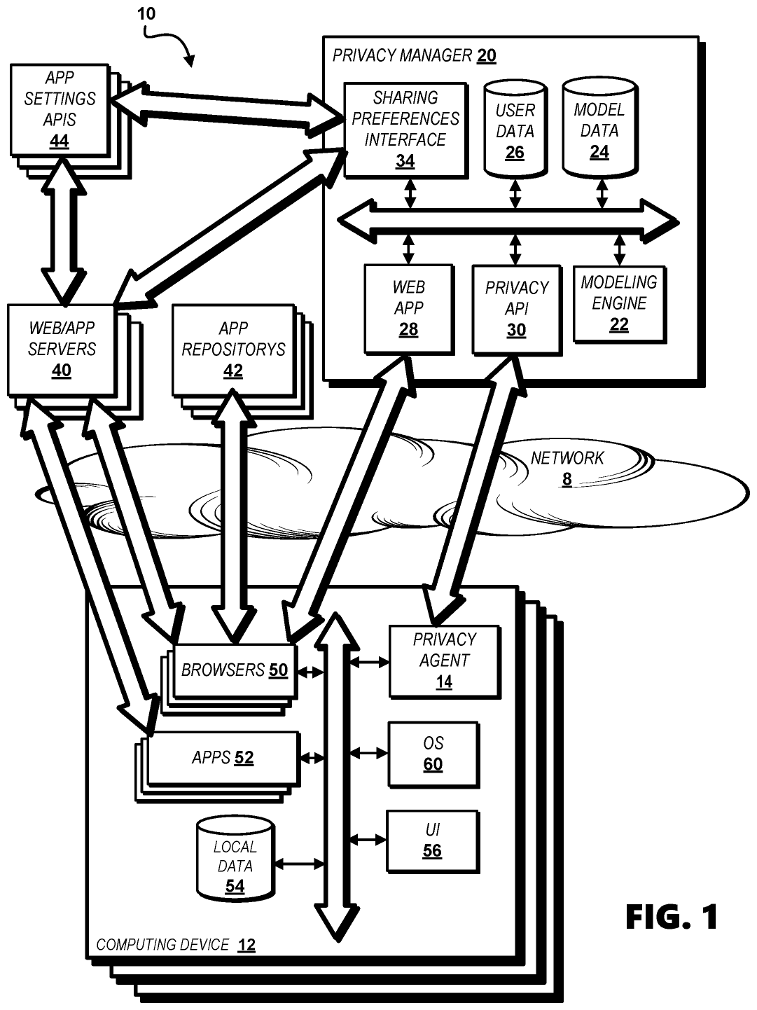

Referring to FIG. 1, a system 10 for managing access by applications to stored user content and for controlling internet browser use is provided. User content are electronic records that can include for example photos, contacts, documents, and clickstreams. The system 10 is provided in a communications network 8 including one or more wired or wireless networks or a combination thereof, for example including a local area network (LAN), a wide area network (WAN), the internet, mobile telephone networks, and wireless data networks such as Wi-Fi™ and 3G/4G/5G cellular networks. Operating system 60 (hereinafter “OS 60”) is executed on computing devices 12. The system 10 enables management of which user content (e.g., which photos, which contacts, which documents, or which clickstreams) is accessible to applications executed by and accessible to a computing device 12. Further, the system 10 enables the providing of a computing environment for a user to manage the user's electronic privacy preferences. The system 10 via a network-accessible processor-enabled privacy manager 20 and privacy agent 14 provides an automated, intuitive, and personalized way for a user to enable access to a user's stored content requiring minimal user input.

The computing device 12 operates in the network 8. The computing device 12 can include for example a smart phone or other cellular-enabled mobile device configured to operate on a wireless telecommunications network. Alternatively, the computing device 12 can include a personal computer, tablet device, or other computing device. A user operates the computing device 12 with a privacy agent 14 active, the privacy agent 14 functioning as a user content sharing filter application on the computing device 12. Software and/or hardware residing on the computing device 12 enables the privacy agent 14 to monitor and restrict content accessible on the computing device 12 by network-based applications or services, for example enabled by a website server or application server 40 (hereinafter “web/app server” 40) or local applications 52 enabled to communicate via the network 8 with the web/app servers 40.

The privacy agent 14 can be configured as a standalone application executable by a processor of the computing device 12 via the OS 60 and in communication with the local applications 52 and the browsers 50. Alternatively, the privacy agent 14 can be provided as a processor-implemented add-on application integral with the local applications 52 or browser 50, or other applications or services. The privacy agent 14 is enabled to restrict or block user content (e.g., photos, contacts, documents, or clickstreams) accessible by local applications 52 or accessible by network-based applications or services, for example enabled by a web/app server 40, or accessible by browsers 50.

The privacy manager 20 facilitates the controlling of sharing of user content stored on a computing device 12. The operation of the privacy manager 20 is described herein with respect to the computing device 12, web/app servers 40, and application settings application program interface (API) 44. One skilled in the art will recognize that the privacy manager 20 can operate with other suitable wired or wireless network-connectable computing systems. The privacy manager 20 includes a modeling engine 22, a model datastore 24, a user datastore 26, a web application program interface (“API”) 28, a privacy application program interface (“API”) 30, and a sharing preferences interface 34. The privacy manager 20 can be implemented on one or more network-connectable processor-enabled computing systems, for example in a peer-to-peer configuration, and need not be implemented on a single system at a single location. The privacy manager 20 is configured for communication via the communications network 8 with other network-connectable computing systems including the computing device 12. Alternatively, the privacy manager 20 or one or more components thereof can be executed on the computing device 12 or other system.

The privacy manager 20 can further enable queries to be provided to a user of a computing device 12. The queries can be provided in a user interface 56 via instructions from a privacy agent 14 based on privacy data stored in a local datastore 54 or based on data transmitted from the privacy API 30 of the privacy manager 20. Alternatively, queries can be provided via the user interface 56 based on data transmitted from the web application 28 enabled by the privacy manager 20 and accessible via a browser 50 executed on the computing device 12. A user's responses to the queries can indicate whether a particular application is allowed access to particular electronic records or whether a particular browser 50 should be used to access a particular network address. Query responses are is stored in a user datastore 26 or a local datastore 54 and used by the privacy manager 20 or the privacy agent 14 in controlling user content accessible to local applications 52 executed by the user's computing device 12 and accessible to network-accessible computing systems hosting websites, webpages of websites, and applications, and used for controlling which browsers are used to access particular network addresses. Applications and websites can include for example social media or messaging applications and platforms for example Facebook™, LinkedIn™, and Google™ social media or messaging applications and platforms. Applications can include standalone applications, plugins, add-ons, or extensions to existing applications, for example web browser plugins. Applications or components thereof can be installed and executed locally on a computing device 12 or installed and executed on remote computing systems accessible to the computing device 12 via a communications network 8, for example the internet.

The sharing preferences interface 34 can search for and download user content shared by a user via a particular application, website, or webpage by accessing a web/app server 40 or by accessing an application settings API 44 which communicates permissions to a web/app server 40. The privacy agent 14 can also search for and download user content shared by a user via a particular application, website, or webpage by accessing a local application 52 with which user content has been shared or by accessing a web/app server 40 (e.g., via a browser 50 or local application 52) with which user content has been shared.

Local applications 52 are beneficially network-enabled, with Web/app servers functioning to enable local applications 52 or particular components of local applications 52. Web/app servers 40 can further enable network-enabled network-based applications, webpages, or services accessible via a browser 50 which need not have application components installed on a computing device 12. Interaction by the sharing preferences interface 34 with web/app servers 40 and application settings APIs 44 is facilitated by applying user credentials provided by a user via the privacy agent 14 or web application 28. Local applications 52 can be downloaded for example via a browser 50 or other local application 52 from an application repository 42. The privacy agent 14 monitors user activity on the computing device 12 including a user's use of local applications 52 and network-based applications, accessing of websites, and explicit and implicit sharing of user content including for example photos, contacts, documents, or clickstreams. Statistics of such use is used by the modeling engine 22 or the privacy agent 14 to build data-driven statistical models of user privacy preference stored in the model datastore 24 of the privacy manager 20 or the local datastore 54 of the computing device 12. The modeling engine 22 can for example function under the assumption that a user would allow sharing of particular types of user content with a particular application if that user had already consented to sharing similar user content with the particular application or similar application in the past.

The privacy agent 14 permits a user to use network-enabled applications, for example particular local applications 52 or network-based applications supported by web/app servers 40, without allowing access to an entire class of electronic records. For example, instead of allowing access to all photos stored on a computing device 12 in a local datastore 54, the privacy agent 14 enables a user to keep some of their photos private. The privacy agent 14 with support from the privacy manager 20 manages which local applications 52 or network-based applications are granted access to which electronic records, for example photos.

In one implementation, particular photos which have already been explicitly shared by a user to a particular local application 52 or particular network-based application are used to determine other photos which are shared with the particular application. Photos which have not been explicitly shared with the particular application, or photos which have not been explicitly shared with the particular application and have been shared with another application are precluded from being shared with the particular application. The privacy agent 14 alone or via the modeling engine 22 learns users' preferences and uses machine learning to decide which photos to share. In other implementations, other data types such as documents or contact records which have already been explicitly shared by a user to a particular local application 52 or particular network-based application are used to determine other documents or contact records which are shared with the particular application. Documents or contact records which have not been explicitly shared with the particular application, or documents or contact records which have not been explicitly shared with the particular application and have been shared with another application are precluded from being shared with the particular application. The privacy agent 14 alone or via the modeling engine 22 learns users' preferences and uses machine learning to decide which documents and contact records to share.

Electronic records are distinguishable by content type. The privacy agent 14 and privacy manager 20 are configured to assign privacy levels to electronic records based on their content type and the classification of data within the electronic record. Thereby within a specific content type, different electronic records are assigned different privacy levels. Referring to Table 1, four exemplary content types of electronic records are listed as “photos,” “contacts” (i.e., an electronic address book), “documents” (e.g., text files), and “clickstream” (i.e., a time ordered sequence of DNS requests including URLs). Example classes for electronic records of each content type are listed. Classifications of photos is beneficially based on artificial neural network image analysis. Classification of contacts and documents is beneficially based on artificial neural network content analysis and can be further based on the source of the contacts or documents, for example which application stores or manages the electronic records of the contacts or documents. Classification of clickstream is beneficially based on artificial neural network analysis of a clustered browser clickstream. Shown also are example applications which are differentiated by content type with respect to user privacy based on a user's prior interactions with the applications. The interactions can include for example sharing electronic records such as photos, contacts, or documents with the applications or using the applications, in the case of a browser application, to access particular network destination.

TABLE 1

| | | Example Differentiated |
|---|---|---|
| Content Type | Example Classes | Apps |
| Photos | People, pets, home, | WhatsApp ™, Instagram ™, |
| | garden, food | Letgo ™ |
| Contacts | Personal, business | Gmail ™, LinkedIn ™, |
| | | Facebook ™ |
| Documents | Medical, financial, | Intuit ™, Banking apps, |
| | professional | Medical apps |
| Clickstream | Personal, professional | Chrome ™, Safari ™, |
| | | Facebook ™ |

Referring to Table 2, exemplary machine learning conclusions enabled by either or both of the privacy agent 14 and the modeling engine 22 are set forth based on a user's photo sharing history with a particular local application 52 or network based application, for example WhatsApp™, Instagram™, or Letgo™ applications. Using a first application (“App #1”) a user explicitly shares their children's photos with members of the user's family. The exemplary machine learning conclusion generated by either or both of the privacy agent 14 and the modeling engine 22 is that access is allowed to other photos of the user's children and to other people, for example other people present in photos of the user's children. Using a second application (“App #2”) a user explicitly shares garden photos. The resulting exemplary machine learning conclusion generated by either or both of the privacy agent 14 and the modeling engine 22 is that access to garden photos and food photos not including people are allowed. Using a third application (“App #3”) a user explicitly shares photos of furniture for sale. The resulting exemplary machine learning conclusion generated by either or both of the privacy agent 14 and the modeling engine 22 is that access to other furniture photos, or other furniture photos not including people, are allowed. Using a third application (“App #4”) a user explicitly shared only one photo. To avoid a machine learning conclusion based on inadequate data, the privacy agent 14 can allow the user to lead and permit access to photos based on explicit user-selected privacy settings or privacy settings inferred from explicit user-selected privacy settings.

TABLE 2

| | User's explicit | |
|---|---|---|
| Apps | sharing history | Example ML Conclusions |
| App#1 | Children's photos, | Allow access to photos of |
| | shared with family | other people or photos of |
| | | other people in photos with |
| | | their children |
| App#2 | Garden photos | Allow access to garden and |
| | | food photos, but not including |
| | | people |
| App#3 | Photos of furniture | Allow access to photos of |
| | for sale | furniture, but not including |
| | | people |
| App#4 | One photo shared | Let user lead, allow access |
| | (new app) | to photos based on user |
| | | selected or inferred privacy |
| | | settings |

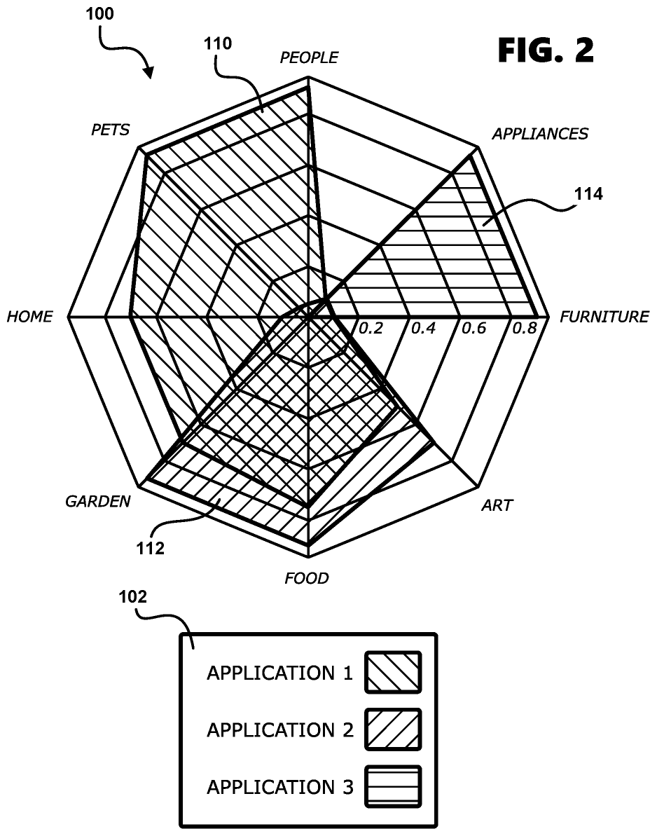

The privacy agent 14 or privacy manager 20 can apply an image classifier to photos in the user's gallery in the local datastore 54 on the user's computing device 12 or stored remotely by the user. The privacy agent 14 or privacy manager 20 can further apply an image classifier to photos shared via network for example via web/app servers 40 and local applications 52 or browsers 50, for example via the WhatsApp™, Instagram™, or Letgo™ applications. The image classifier can assign scores or probabilities to each photo to reflect the content of each photo. Referring to FIG. 2, an exemplary photo classification graph 100 corresponding to photos shared with particular applications allows for visualizing the content of images explicitly shared by the user to particular applications. In view of a key 102 of the photo classification graph 100, it is shown via a first shading 110 that photos shared to the first application (“Application 1”) include a high number of pet and people images, include to a lesser extent home, garden, and food images, include to an even lesser extent art images, and do not include to a significant extent furniture and appliance images. It is shown via a second shading 112 that photos shared to the second application (“Application 2”) include a relatively high number of garden, food, and art images and do not include to a significant extent furniture, appliances, people, pets, and home images. It is shown via a third shading 114 that photos shared to the third application (“Application 3”) include a high number of appliance and furniture images and do not include people, pets, home, garden, food, and art images.

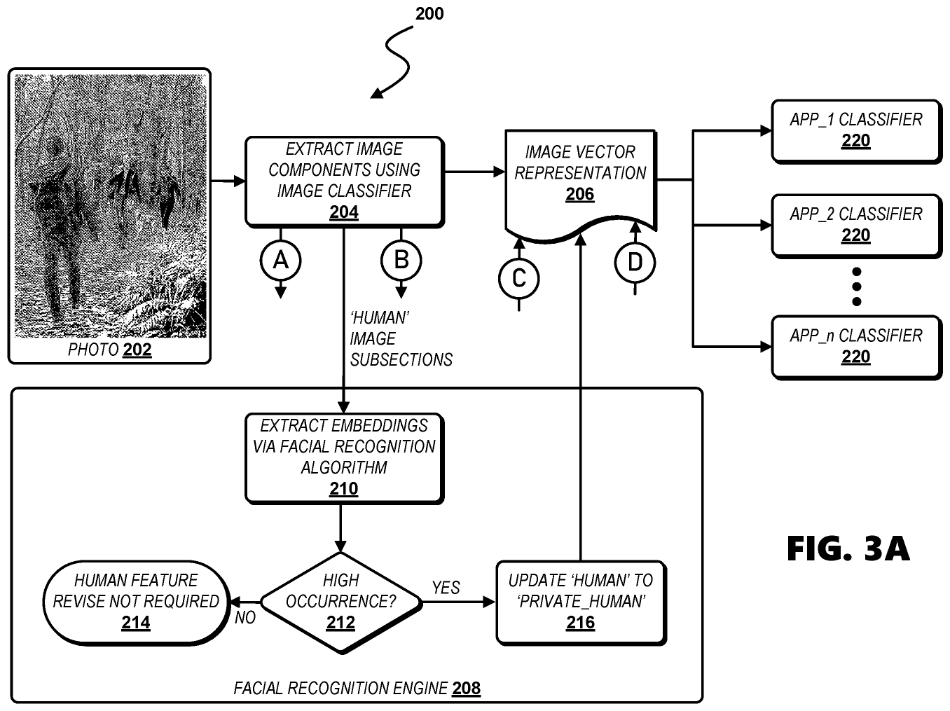

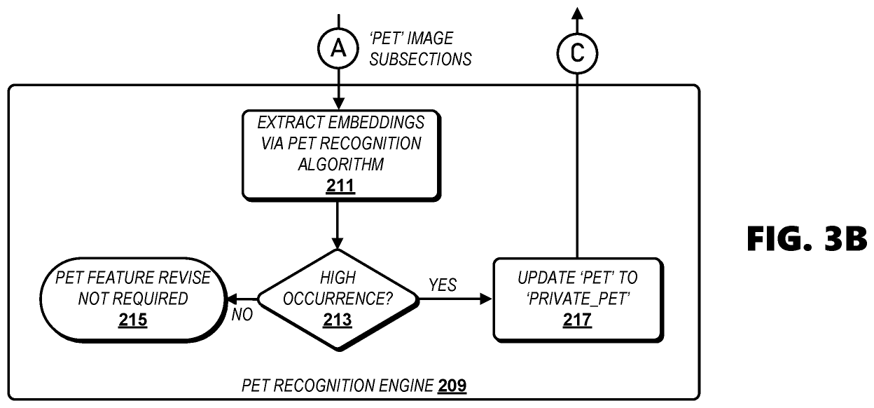

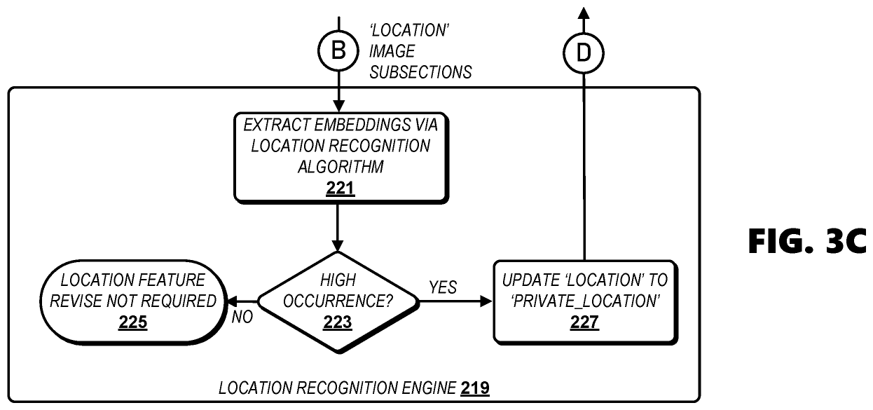

Referring to FIGS. 3A-3C, a diagram illustrates a process flow 200 used in inferring application-specific photo sharing polices and used in training application-specific photo sharing classifiers 220 for inferring application-specific photo sharing policies for a user. An image classifier is applied to a photo 202 stored by a user to extract image components (step 204), and an image vector representation 206 is generated based on the extracted image components. Extracted image components beneficially include indications of objects (e.g., first human, second human, third human, dog, food), locations (e.g., street, city, park, woods, kitchen, living room, or other environments), and activities (e.g., hiking, biking, swimming) shown in an image. If one or more human image components are extracted in step 204, subsections of the photo 202 corresponding to the human image components are forwarded to a facial recognition engine 208. The facial recognition engine 208 proceeds with an image vector update process, first attempting to extract embeddings from each human face via a facial recognition algorithm (step 210).

The facial recognition algorithm beneficially includes a convolutional neural network (“CNN”) that extracts the embeddings, the embeddings including features from facial images such as distance between human eyes and width of a human forehead. These embeddings are used as representations on faces. Classifiers, for example support vector machine (“SVM”) or k nearest neighbor (“K-NN”), included in the facial recognition algorithm, can be used to identify particular humans. Known facial recognition algorithms include DeepFace and FaceNet.

In a step 212, it is determined if the extracted embeddings correspond to a human detected frequently, for example a human detected a threshold number of times in one or more other photos 202 stored by the user. If a user captures and stores a large number of photos of a particular human, this may suggest the particular human is important to the user and the user may consider the preservation of the particular human's privacy to be important. It can be beneficial for example to tag the particular human as a target whose privacy should be preserved.

If the extracted embeddings correspond to a human detected a threshold number of times, the image vector representation 206 is updated for each such detected human (step 216). For example a vector representation indicating the presence of a human is replaced with a vector representation indicating the presence of a frequently imaged human (“private human”). If the extracted embeddings correspond to a human which has not been detected a threshold number of times in the user's stored photos, no revision is performed and the image vector update process is discontinued (step 214). The image vector representation 206 is fed into the photo sharing classifiers 220 for a plurality of different applications to determine if the photo 202 should be shareable with the each application, or in other words if the photo 202 should be accessible to a particular application.

If one or more pet image components (e.g., dog, cat, parrot, or other animal generally associated with a pet) are extracted in step 204, subsections of the photo 202 corresponding to the pet image components are forwarded to a pet recognition engine 209 (input “A”). The pet recognition engine 209 proceeds with an image vector update process, first attempting to extract embeddings from each pet via a pet recognition algorithm (step 211).

The pet recognition algorithm beneficially includes a convolutional neural network (“CNN”) that extracts the embeddings, the embeddings including unique identifying features of the pets. These embeddings are used as representations on pets. Classifiers, for example support vector machine (“SVM”) or k nearest neighbor (“K-NN”), included in the pet recognition algorithm, can be used to identify particular pets.

In a step 213, it is determined if the extracted embeddings correspond to a pet detected frequently, for example a pet detected a threshold number of times in one or more other photos 202 stored by the user. If a user captures and stores a large number of photos of a particular pet, this may suggest the particular pet is important to the user and the user may consider the preservation of the particular pet's privacy or the privacy of those in the company of the particular pet to be important. It can be beneficial for example to tag the particular pet or an individual in the company of the pet as a target whose privacy should be preserved.

If the extracted embeddings correspond to a pet detected a threshold number of times, the image vector representation 206 is updated (output “C”) for each such detected pet (step 217). For example a vector representation indicating the presence of a dog is replaced with a vector representation indicating the presence of a frequently imaged dog (“private pet”). If the extracted embeddings correspond to a pet which has not been detected a threshold number of times in the user's stored photos, no revision is performed and the image vector update process is discontinued (step 215).

If one or more location image components (e.g., street, city, park, woods, kitchen, living room, or other environments) are extracted in step 204, subsections of the photo 202 corresponding to the location image components are forwarded to the location recognition engine 219 (input “B”). The location recognition engine 219 proceeds with an image vector update process, first attempting to extract embeddings from each location via a location recognition algorithm (step 221).

The location recognition algorithm beneficially includes a convolutional neural network (“CNN”) that extracts the embeddings, the embeddings including unique identifying features of the locations. These embeddings are used as representations on locations. Classifiers, for example support vector machine (“SVM”) or k nearest neighbor (“K-NN”), included in the location recognition algorithm, can be used to identify particular locations.

In a step 223, it is determined if the extracted embeddings correspond to a location detected frequently, for example a location detected a threshold number of times in one or more other photos 202 stored by the user. If a user captures and stores a large number of photos of a particular location, this may suggest the particular location is important to the user and the user may consider the privacy of activity occurring in the particular location to be important. It can be beneficial for example to tag the particular location as a target where private activity occurs.

If the extracted embeddings correspond to a location detected a threshold number of times, the image vector representation 206 is updated (output “D”) for each such detected location (step 227). For example a vector representation indicating the presence of a kitchen is replaced with a vector representation indicating the presence of a frequently imaged location (“private location”). If the extracted embeddings correspond to a location which has not been detected a threshold number of times in the user's stored photos, no revision is performed and the image vector update process is discontinued (step 225). In addition to the facial recognition engine 208, pet recognition engine 209, and location recognition engine 219, additional engines or architecture can be provided for identifying and logging occurrences of various other features in photos 202 stored by the user and updating the image vector representation 206 based on the identified occurrences.

Training the photo sharing classifiers 220 is performed by accessing photos 202 explicitly shared by the user to one or more particular applications within a group of applications used by the user and to which sharing privacy is to be differentiated. Accessing shared photos 202 on web/app servers 40 enabling the group of applications can be performed by the privacy manager 20 via a sharing preferences interface 34 or by the privacy agent 14 via local applications 52 or browsers 50. During training, the explicitly shared photos 202 are entered into the process flow 200 as described herein. The output of each photo sharing classifier 220 is set as “share” for those applications in the group to which the photo 202 has been explicitly shared and “do not share” for those applications in the group to which the photo 202 has not been explicitly shared. This process is beneficially performed for each photo 202 explicitly shared by at least one application in the group. An application group can include for example one or more of social networking applications, messaging applications, or marketplace applications. For example a group of applications to be differentiated by image sharing policy can include WhatsApp™, Instagram™, and Letgo™.

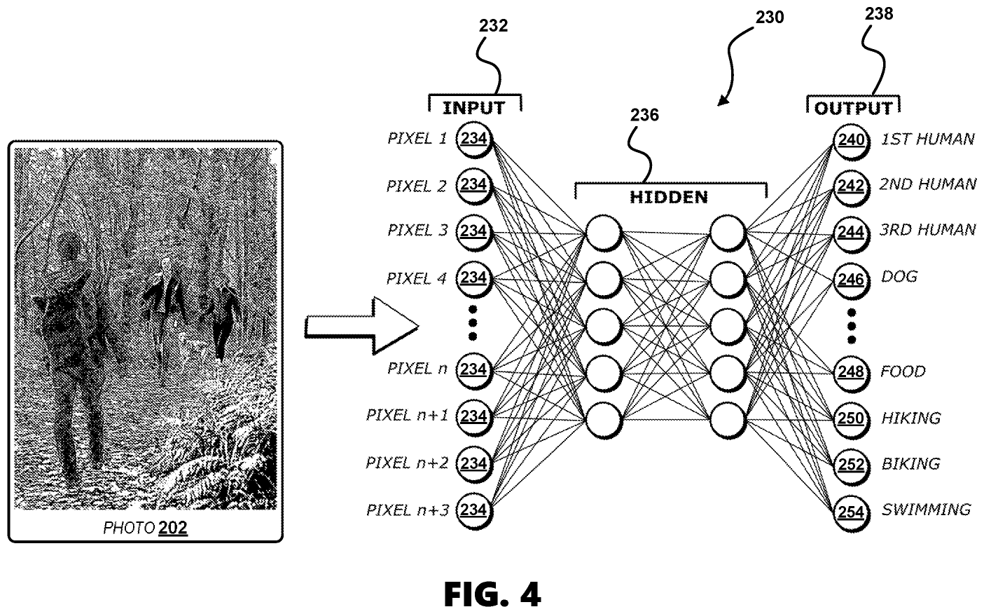

Referring to FIG. 4, an exemplary image classifier 230 is shown in the form of a convolutional neural network (“CNN”) for extracting the image components of the photo 202 by step 204 of the process flow 200 to facilitate making a privacy determination regarding the photo. The image classifier 230 includes an input layer 232 including pixel data 234, for example color data or shading data, for each pixel in the photo 202. An output layer 238 comprises particular image components which may be extracted from a photo 202 and which are represented as a plurality of probabilities of occurrences, one probability of occurrence for each image component represented in the output layer. FIG. 4 shows exemplary object image components as nodes including a first human 240, second human 242, third human 244, dog 246, food 248 and exemplary activity image components as nodes including hiking 250, biking 252, and swimming 254. Extracted image components can further include locations (e.g., street, city, park, woods, kitchen, living room, or other environments) and other objects and activities. Hidden layers of nodes 236 are shown for convenience of illustration as two five node rows. Alternatively, other suitable number and arrangement of hidden nodes can be implemented. Beneficially, the CNN is configured as a multi-layered CNN with multiple dense and sparse connections. Example CNN architectures include ResNet, InceptionNet, and EfficientNet-L2. The more distinct objects that the image classifier 230 can identify, the more detailed or focused the privacy determination facilitated by the image classifier 230. Alternatively, a YOLO algorithm can be used to run an image classifier on sections of an image to identify multiple objects.

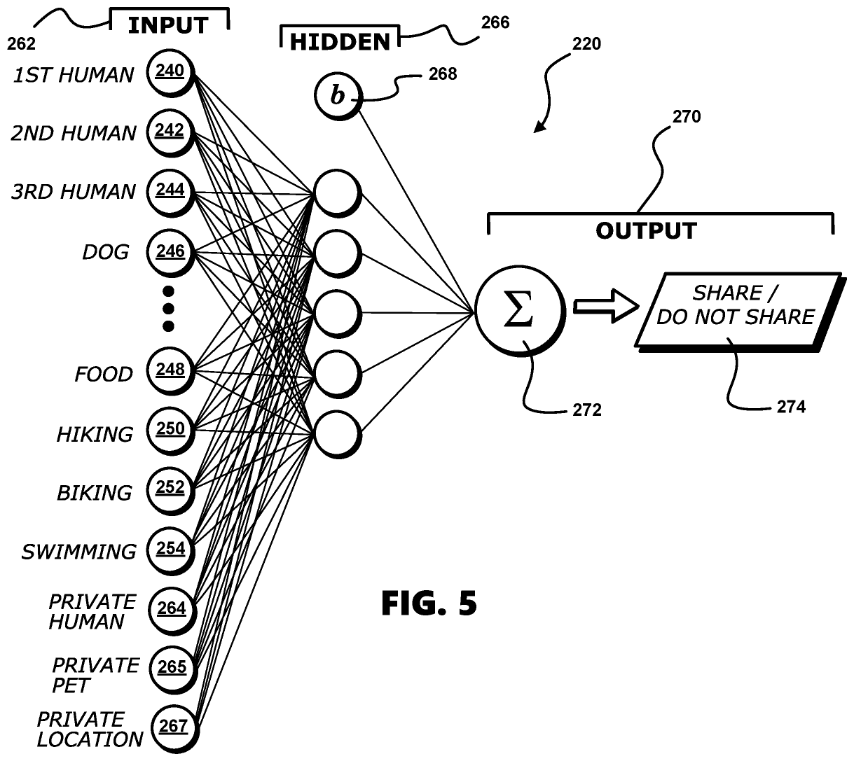

Referring to FIG. 5, the photo sharing classifier 220 is shown in the form of a support vector machine (“SVM”) classifier. Alternatively other classifier configurations can be implemented, for example a k-nearest neighbor algorithm (“k-NN”) classifier or decision tree classifier. The output 238 of the image classifier 230 is used for the input 262 of the photo sharing classifier 220 with the addition of three or more nodes representing a private human 264, private pet 265, and private location 267. Beneficially, in the case where each node of the output 238 of the image classifier 230 is determined as a decimal probability, each node of the output 238 can be rounded to one (1) or zero (0) prior to feeding it in vector form to the input 262 of the photo sharing classifier 220. For example a vector representation of output 238 of [0.92, 0.84, 0.78, 0.65, . . . 0.05, 0.71, 0.03, 0.01] corresponding to the first human 240, second human 242, third human 244, dog 246, . . . food 248, hiking 250, biking 252, and swimming 254 can be rounded to [1, 1, 1, 1, . . . 0, 1, 0, 0]. If no private human 264, private pet 265, or private location 267 is determined by the facial recognition engine 208, pet recognition engine 209, or the location recognition engine 219, the private human 264, private pet 265, private location 267 can for example each be set to zero (0) resulting in an exemplary vector of [1, 1, 1, 1, . . . 0, 1, 0, 0, 0, 0, 0] to be used as the input 262. If the third human 244 is determined to be a private human 264 by the facial recognition engine 208, the private human 264 can for example be set to one (1) and the third human 244 can be changed from one (1) to zero (0) resulting in an exemplary vector of [1, 1, 0, 1, . . . 0, 1, 0, 0, 1, 0, 0] to be used as the input 262. If the dog 246 is determined to be a private pet 265 by the pet recognition engine 209, the private pet 265 can for example be set to one (1) and the dog 246 can be changed from one (1) to zero (0) resulting in an exemplary vector of [1, 1, 0, 0, . . . 0, 1, 0, 0, 0, 1, 0] to be used as the input 262. If a private location 267 is determined by the location recognition engine 219, the private location 267 can for example be set to one (1) and a corresponding location elsewhere in the input 262 can be changed from one (1) to zero (0) resulting in an exemplary vector of [1, 1, 0, 0, . . . 0, 1, 0, 0, 0, 0, 1] to be used as the input 262. A hidden layer of nodes 266 including a bias 268 is shown for convenience of illustration as a five node row. Alternatively, other suitable number of hidden nodes can be implemented. A privacy determination output 270 includes a summation node 272 for aggregating values from the hidden layer 266 to produce a photo sharing determination 274 that indicates either that the photo 202 should be shared or should not be shared with the application represented by the photo sharing classifier 220.

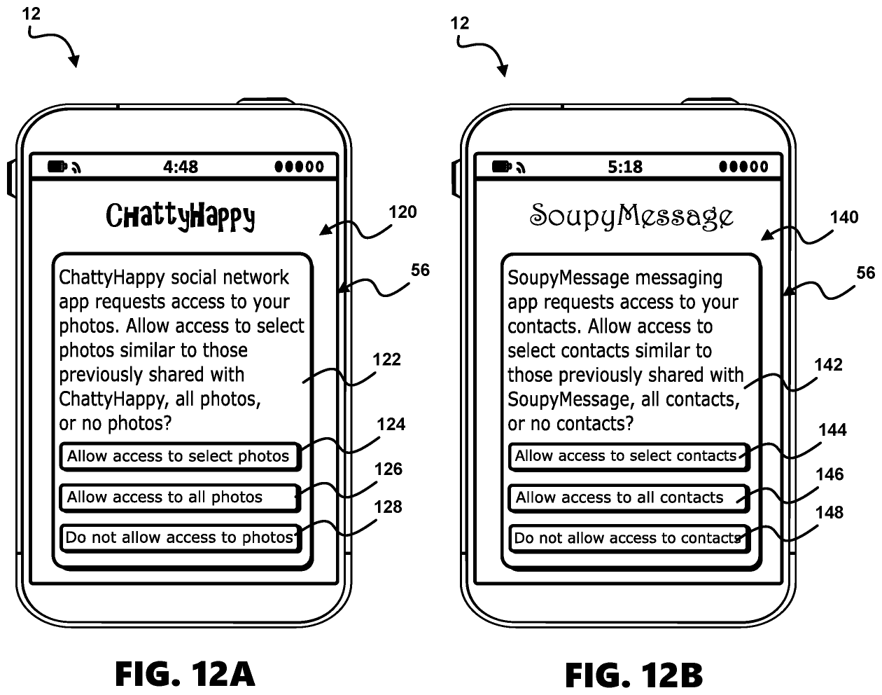

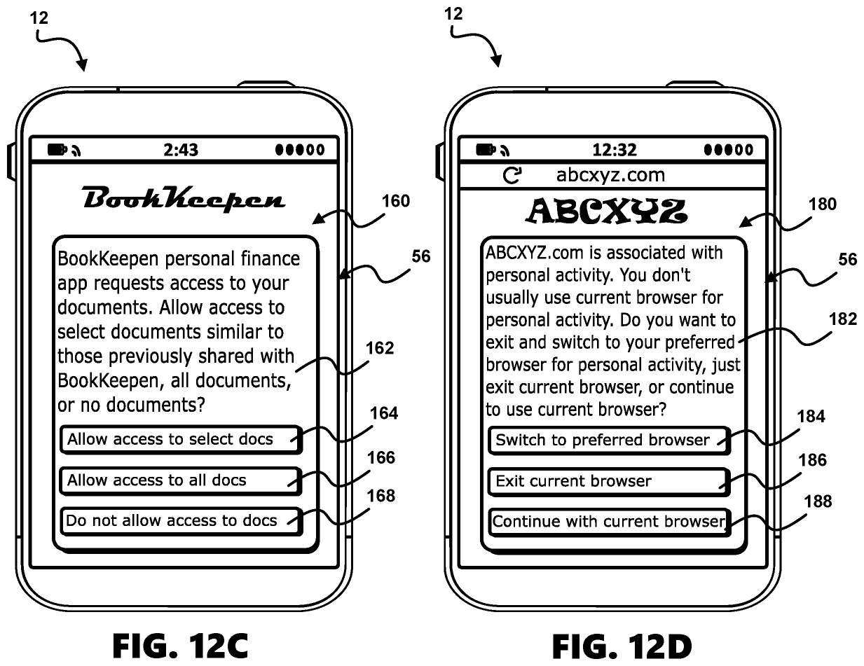

The privacy agent 14 beneficially institutes photo sharing controls based on the photo sharing determination 274, for example disabling access to the photo 202 responsive to a request to access all photos stored on the computing device 12 by the local application 52 or network-based application corresponding to the photo sharing classifier 220. The privacy agent 14 can institute the photo sharing controls without user intervention. Alternatively, the privacy agent 14 can request user input prior to instituting photo sharing controls. Referring to FIG. 12A, the privacy agent 14 generates a first exemplary interactive display 120 via the user interface 56 of the computing device 12 responsive to a particular local application 52 (“ChattyHappy”) requesting access to photos stored in the local datastore 54. The first exemplary interactive display 120 includes a first notice 122 which reads “ChattyHappy social network app requests access to your photos. Allow access to select photos similar to those previously shared with ChattyHappy, all photos, or no photos?” The first notice 122 includes an “allow access to select photos” button 124 to allow access to photos indicated by the photo sharing determination 274 of the photo sharing classifier 220 as allowed to be shared. The first notice 122 also includes an “allow access to all photos” button 126 to allow access to all photos irrespective of the photo sharing determination 274 of the photo sharing classifier 220. The first notice 122 further includes a “do not allow access to photos” button 128 to disallow access to all photos irrespective of the photo sharing determination 274 of the photo sharing classifier 220.

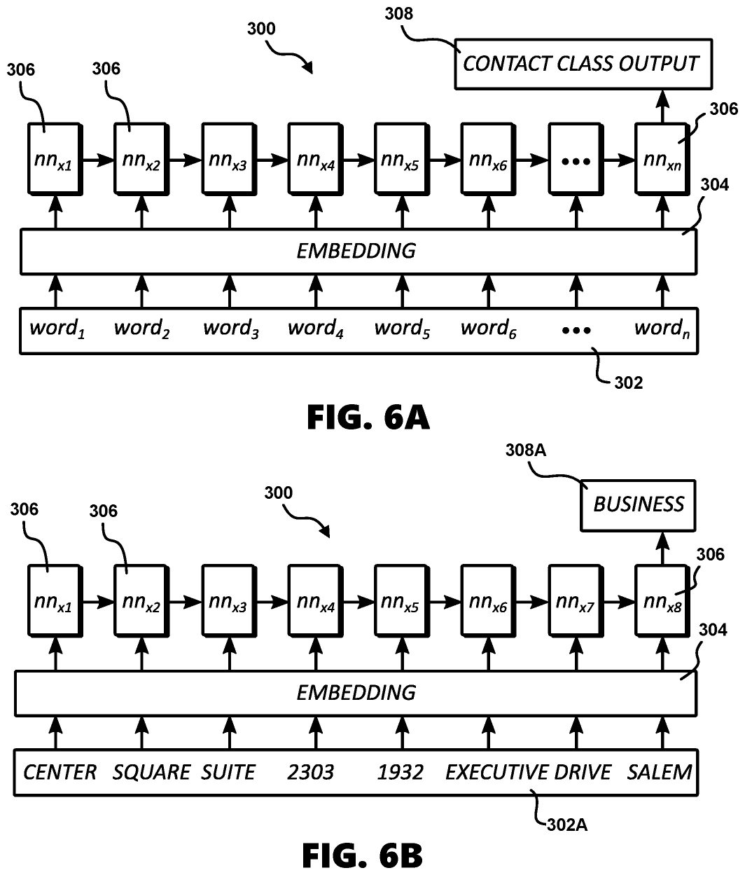

The privacy agent 14 with support from the privacy manager 20 further manages which local applications 52 or web/app servers 40 are granted access to electronic records including contacts. For example, particular applications within a group of applications used by a user are differentiated based on whether a user has explicitly shared personal contacts, business contacts, or both to the particular applications. Referring to FIG. 6A, an exemplary contact classifier 300 in the form of a first recurrent neural network (“RNN”) is shown useful for identifying topics described in a contact record, for example a business or personal contact record stored on a user's computing device 12. Alternatively, other classifier types can be implemented such as Naïve Bayes, logistic regression, decision tree, boosted tree, support vector machine, convolutional neural network, nearest neighbor, dimensionality reduction algorithm, or gradient boosting algorithm classifiers. The contact classifier 300 includes an input layer 302, an embedding layer 304, hidden nodes 306, and a contact class output 308. The input layer 302 includes ordered words (word₁, word₂, . . . wordₙ) extracted by the privacy agent 14 from a contact record accessed from a local datastore 54, or extracted by the privacy agent 14 from a web/app server 40 via a local application 52 or browser 50, or extracted by the privacy manager 20 from a web/app server 40 via the sharing preferences interface 34. The ordered words can include names, addresses, phrases, sentences, sentence fragments, or paragraphs. The contact classifier 300 can be run for example by the modeling engine 22 of the privacy manager 20 based on contact records received from the sharing preferences interface 34 or privacy agent 14. Alternatively, the contact classifier 300 can be run by the privacy agent 14. The embedding layer 304 creates vector representations of the input words. The hidden nodes 306 sequentially implement neural network algorithms (nnx₁, nnx₂, . . . nnₓₙ) on vectorized words providing feedback to subsequent nodes 306 to generate the contact class output 308. The contact class output 308 includes at least a designation of whether a particular contact record is classified as business or personal or both. Additional classifications can be determined in place of or in addition to business or personal classifications, and classifications need not correspond to particular labels or be human interpretable.

Referring to FIG. 6B, an exemplary implementation of the contact classifier 300 is shown in which the address portion “CENTER SQUARE SUITE 2303 1932 EXECUTIVE DRIVE SALEM” is input as an input layer 302A, and the contact class output 308A is determined as “BUSINESS” by the contact classifier 300. The contact classifier 300 can be trained automatically for example by designating particular predefined keywords or key phrases as corresponding to a specified contact class output, and using the sentences and phrases near in location to the predefined keywords or key phrases as the classifier inputs. For example, a phrase in a particular contact record including the word “accountant” can be designated as corresponding to a “BUSINESS” contact class output 308A, and other words or phrases near in location to the word “accountant” in the particular contact record can be input to the contact classifier 300 to train for the “BUSINESS” contact class output 308A.

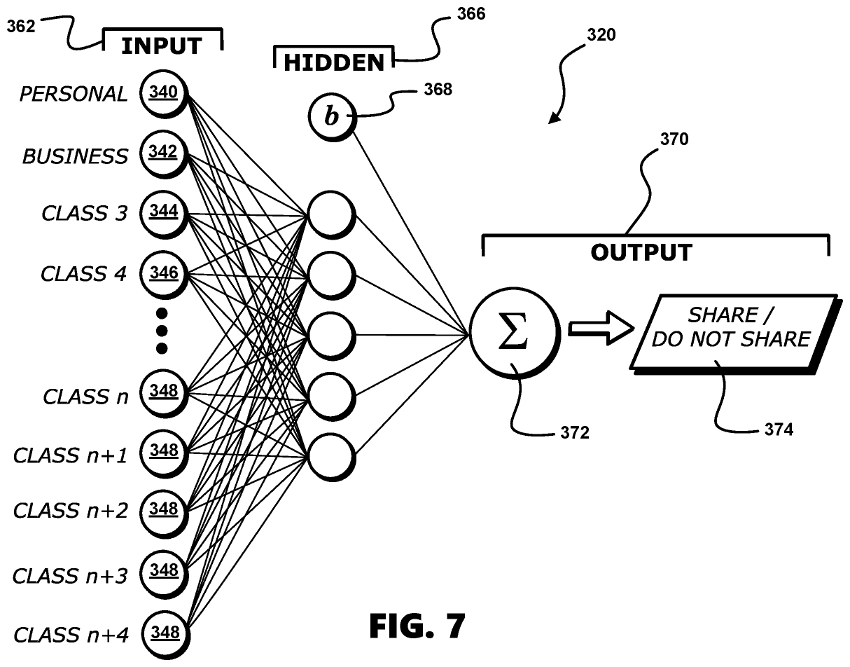

Referring to FIG. 7, a contact sharing classifier 320 is shown in the form of a support vector machine (“SVM”) classifier. The contact class output 308 of the contact classifier 300 is used for the input 362 of the contact sharing classifier 320. Beneficially, in the case where each node of the contact class output 308 of the contact classifier 300 is determined as a decimal probability, each node of the contact class output 308 can be rounded to one (1) or zero (0) prior to feeding it in vector form to the input 362 of the contact sharing classifier 320. In addition to business 340 and personal 342 classifications, additional labeled or unlabeled classifications represented by class three 344, class four 346 and classes n through n+4 348 are shown. For example a vector representation of the contact class output 308 of [0.81, 0.19, 0.01, 0.04, . . . 0.1, 0.01, 0.02, 0.02, 0.01] including business 340, personal 342, class three 344, class four 346, and classes n through n+4 348 can be rounded to [1, 0, 0, 0, . . . 0, 0, 0, 0, 0]. A hidden layer of nodes 366 including a bias 368 is shown for convenience of illustration as a five node row. Alternatively, other suitable number of hidden nodes can be implemented. An output 370 includes a summation node 372 for aggregating values from the hidden layer 366 to produce a contact sharing determination 374 that indicates whether the analyzed contact record should be shared or should not be shared with the application represented by the contact sharing classifier 320.

The privacy agent 14 beneficially institutes contact sharing controls based on the contact sharing determination 374, for example disabling access to an analyzed contact responsive to a request to access all contacts stored on the computing device 12 by the local application 52 or network-based application corresponding to the contact sharing classifier 320. The privacy agent 14 can institute the contact sharing controls without user intervention. Alternatively, the privacy agent 14 can request user input prior to instituting contact sharing controls. Referring to FIG. 12B, the privacy agent 14 generates a second exemplary interactive display 140 via the user interface 56 of the computing device 12 responsive to a particular local application 52 (“SoupyMessage”) requesting access to contacts stored in the local datastore 54. The second exemplary interactive display 140 includes a second notice 142 which reads “SoupyMessage messaging app requests access to your contacts. Allow access to select contacts similar to those previously shared with SoupyMessage, all contacts, or no contacts?” The second notice 142 includes an “allow access to select contacts” button 144 to allow access to contacts indicated by the contact sharing determination 374 of the contact sharing classifier 320 as allowed to be shared. The second notice 142 also includes an “allow access to all contacts” button 146 to allow access to all contacts irrespective of the contact sharing determination 374 of the contact sharing classifier 320. The second notice 142 further includes a “do not allow access to contacts” button 148 to disallow access to all contacts irrespective of the contact sharing determination 374 of the contact sharing classifier 320.

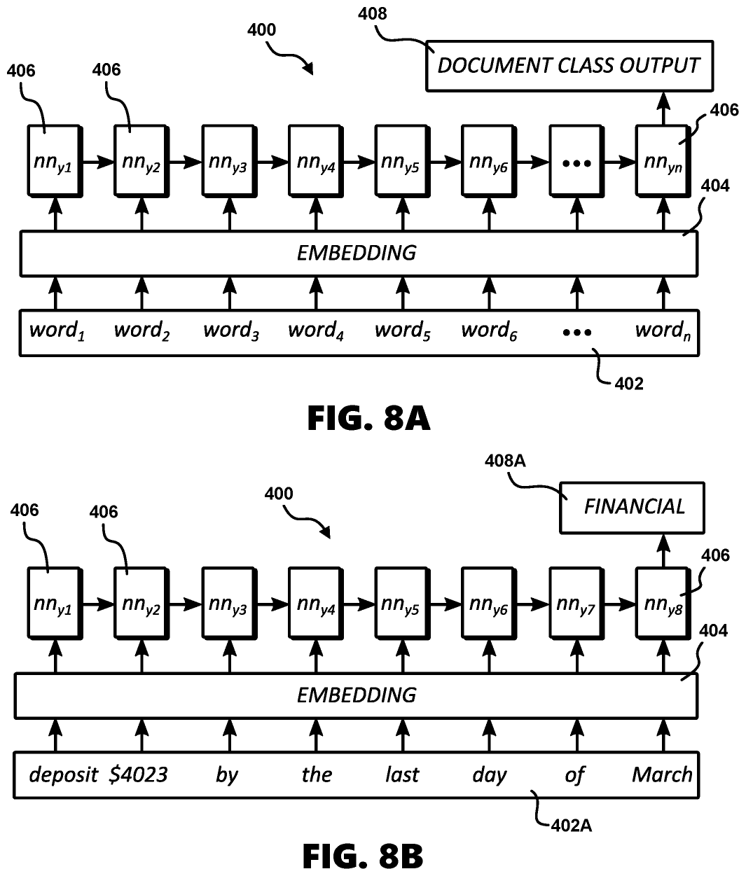

The privacy agent 14 with support from the privacy manager 20 further manages which local applications 52 or web-based applications are granted access to electronic records including documents. For example, particular applications within a group of applications used by a user are differentiated based on whether a user has explicitly shared medical documents, financial documents, or professional documents to the particular applications. Referring to FIG. 8A, an exemplary document classifier 400 in the form of a second recurrent neural network (“RNN”) is shown useful for identifying topics described in a document record, for example a medical, financial, or professional document record stored on a user's computing device 12. Alternatively, other classifier types can be implemented such as Naïve Bayes, logistic regression, decision tree, boosted tree, support vector machine, convolutional neural network, nearest neighbor, dimensionality reduction algorithm, or gradient boosting algorithm classifiers. The document classifier 400 includes an input layer 402, an embedding layer 404, hidden nodes 406, and a document class output 408. The input layer 402 includes ordered words (word₁, word₂, . . . wordₙ) extracted by the privacy agent 14 from a document record accessed from a local datastore 54, or extracted by the privacy agent 14 from a web/app server 40 via a local application 52 or browser 50, or extracted by the privacy manager 20 from a web/app server 40 via the sharing preferences interface 34. The ordered words can include names, addresses, phrases, sentences, sentence fragments, or paragraphs. The document classifier 400 can be run for example by the modeling engine 22 of the privacy manager 20 based on document records received from the sharing preferences interface 34 or privacy agent 14. Alternatively, the document classifier 400 can be run by the privacy agent 14. The embedding layer 404 creates vector representations of the input words. The hidden nodes 406 sequentially implement neural network algorithms (nn_{y1}, nn_{y2}, . . . nn_{yn}) on vectorized words providing feedback to subsequent nodes 406 to generate the document class output 408. The document class output 408 includes at least a designation of whether a particular document record is classified as one or more of medical, financial, or professional. Additional classifications can be determined in place of or in addition to medical, financial, or professional classifications, and classifications need not correspond to particular labels or be human interpretable.

Referring to FIG. 8B, an exemplary implementation of the document classifier 400 is shown in which the text “deposit $4023 by the last day of March” is input as an input layer 402A, and the document class output 408A is determined as “FINANCIAL” by the document classifier 400. The document classifier 400 can be trained automatically for example by designating particular predefined keywords or key phrases as corresponding to a specified document class output, and using the sentences and phrases near in location to the predefined keywords or key phrases as the classifier inputs. For example, a phrase in a particular contact record including the word “dollars” can be designated as corresponding to a “FINANCIAL” document class output 408A, and other words or phrases near in location to the word “dollars” in the particular contact record can be input to the document classifier 400 to train for the “FINANCIAL” document class output 408A.

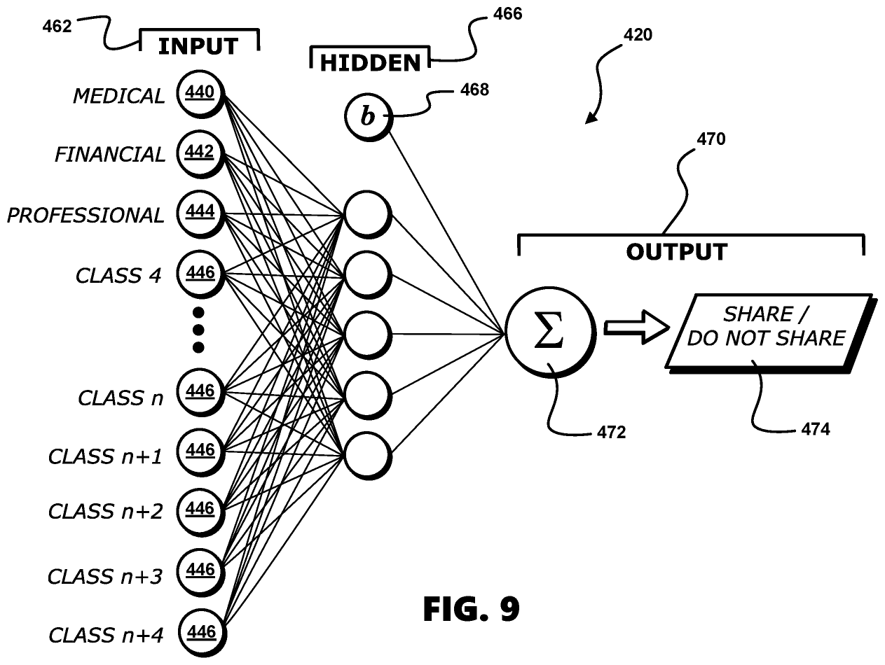

Referring to FIG. 9, a document sharing classifier 420 is shown in the form of a support vector machine (“SVM”) classifier. The document class output 408 of the document classifier 400 is used for the input 462 of the document sharing classifier 420. Beneficially, in the case where each node of the document class output 408 of the document classifier 400 is determined as a decimal probability, each node of the document class output 408 can be rounded to one (1) or zero (0) prior to feeding it in vector form to the input 462 of the document sharing classifier 420. In addition to medical 440, financial 442, and professional 444 classifications, additional labeled or unlabeled classifications represented by class four 446 and classes n through n+4 448 are shown. For example a vector representation of the document class output 408 of [0.74, 0.09, 0.01, 0.03 . . . 0.14, 0.06, 0.09, 0.07, 0.04] including medical 440, financial 442, professional 444, class four 446, and classes n through n+4 446 can be rounded to [1, 0, 0, 0 . . . 0, 0, 0, 0, 0]. A hidden layer of nodes 466 including a bias 468 is shown for convenience of illustration as a five node row. Alternatively, other suitable number of hidden nodes can be implemented. An output 470 includes a summation node 472 for aggregating values from the hidden layer 466 to produce a document sharing determination 474 that indicates whether the analyzed document record should be shared or should not be shared with the application represented by the document sharing classifier 420.

The privacy agent 14 beneficially institutes document sharing controls based on the document sharing determination 474, for example disabling access to an analyzed document responsive to a request to access all documents stored on the computing device 12 by the local application 52 or network-based application corresponding to the document sharing classifier 420. The privacy agent 14 can institute the document sharing controls without user intervention. Alternatively, the privacy agent 14 can request user input prior to instituting document sharing controls. Referring to FIG. 12C, the privacy agent 14 generates a third exemplary interactive display 160 via the user interface 56 of the computing device 12 responsive to a particular local application 52 (“BookKeepen”) requesting access to documents stored in the local datastore 54. The third exemplary interactive display 160 includes a third notice 162 which reads “BookKeepen personal finance app requests access to your documents. Allow access to select documents similar to those previously shared with BookKeepen, all documents, or no documents?” The third notice 162 includes an “allow access to select docs” button 164 to allow access to documents indicated by the document sharing determination 474 of the document sharing classifier 420 as allowed to be shared. The third notice 162 also includes an “allow access to all docs” button 166 to allow access to all documents irrespective of the document sharing determination 474 of the document sharing classifier 420. The third notice 162 further includes a “do not allow access to docs” button 168 to disallow access to all documents irrespective of the document sharing determination 474 of the document sharing classifier 420.

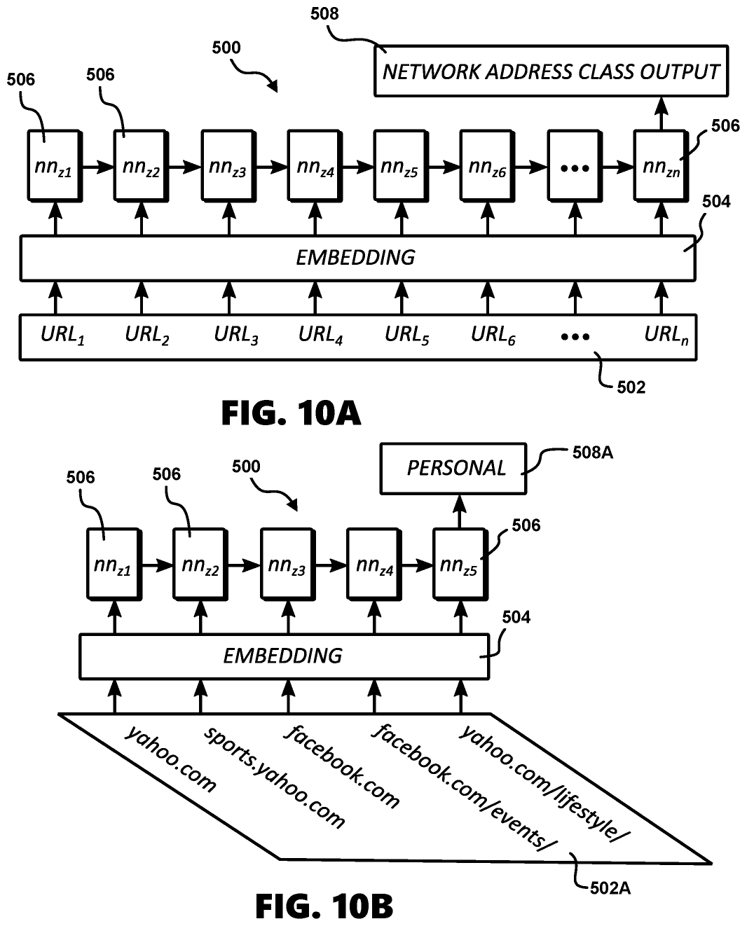

The privacy agent 14 with support from the privacy manager 20 further manages which browsers 50 are to be used in accessing particular network destinations via web/app servers 40. For example, particular browsers within a group of browsers used by a user are differentiated based on which browsers of the group have been used by the user to accessed particular network destinations. Referring to FIG. 10A, an exemplary network address classifier 500 in the form of a third recurrent neural network (“RNN”) is shown useful for identifying a type of network usage based on Domain Name System (“DNS”) requests by the user via a browser 50. Type of network usage can be for example be personal or professional or other suitable classification of use. Alternatively, other classifier types can be implemented such as Naïve Bayes, logistic regression, decision tree, boosted tree, support vector machine, convolutional neural network, nearest neighbor, dimensionality reduction algorithm, or gradient boosting algorithm classifiers. The network address classifier 500 includes an input layer 502, an embedding layer 504, hidden nodes 506, and a network address class output 508. The input layer 502 beneficially includes a clickstream or any time-ordered sequence of DNS requests (URL₁, URL₂, . . . URLₙ) initiated by a browser 50 in use by a user of the computing device 12. The network address classifier 500 can be run for example by the modeling engine 22 of the privacy manager 20 based on a clickstream monitored by the privacy agent 14 on the computing device 12. Alternatively, the network address classifier 500 can be run by the privacy agent 14. The embedding layer 504 creates vector representations of the input URLs. The hidden nodes 506 sequentially implement neural network algorithms (nn_{z1}, nn_{z2}, . . . nn_{zn}) on vectorized URLs providing feedback to subsequent nodes 506 to generate the network address class output 508. The network address class output 508 includes at least a designation of whether a particular stream of URLs is classified as one or more of personal or professional. Additional classifications can be determined in place of or in addition to personal or professional classifications, and classifications need not correspond to particular labels or be human interpretable.

Referring to FIG. 10B, an exemplary implementation of the network address classifier 500 is shown in which a time ordered sequence of DNS requests including “yahoo.com,” “sports.yahoo.com,” “facebook.com,” “facebook.com/events/,” and “yahoo.com/lifestyle/” are input as an input layer 502A, and the network address class output 508A is determined as “PERSONAL” by the network address classifier 500. The network address classifier 500 can be trained automatically for example by designating particular predefined URLs as corresponding to a specified network address class output, and using the DNS requests (URLs) near in time to the predefined URLs as the classifier inputs. For example, a URL including the word “fun” can be designated as corresponding to a “PERSONAL” network address class output 508A, and other DNS requests (URLs) near in time to the URL including the word “fun” can be input to the network address classifier 500 to train for the “PERSONAL” network address class output 508A.

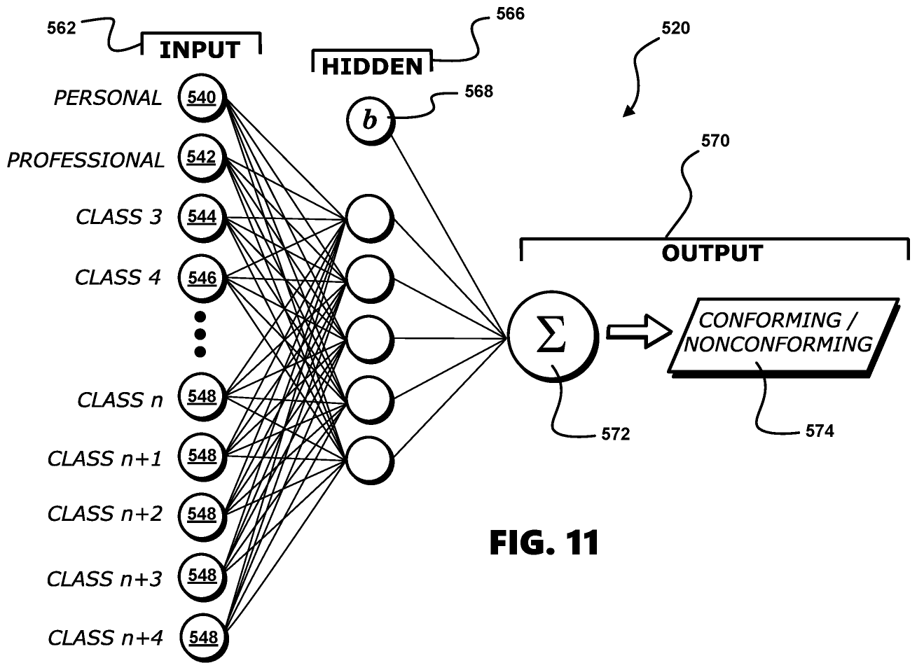

Referring to FIG. 11, a browser use classifier 520 is shown in the form of a support vector machine (“SVM”) classifier. The network address class output 508 of the network address classifier 500 is used for the input 562 of the browser use classifier 520. Beneficially, in the case where each node of the network address class output 508 of the network address classifier 500 is determined as a decimal probability, each node of the network address class output 508 can be rounded to one (1) or zero (0) prior to feeding it in vector form to the input 562 of the browser use classifier 520. In addition to personal 540 and professional 542 classifications, additional labeled or unlabeled classifications represented by class three 544, class four 546 and classes n through n+4 548 are shown. For example a vector representation of the network address class output 508 of [0.25, 0.75, 0.06, 0.09, . . . 0.2, 0.05, 0.07, 0.01, 0.04] including personal 540, professional 542, class three 544, class four 546, and classes n through n+4 548 can be rounded to [0, 1, 0, 0, . . . 0, 0, 0, 0, 0]. A hidden layer of nodes 566 including a bias 568 is shown for convenience of illustration as a five node row. Alternatively, other suitable number of hidden nodes can be implemented. An output 570 includes a summation node 572 for aggregating values from the hidden layer 566 to produce a conformance determination 574 that indicates whether the analyzed time ordered sequence of DNS requests (e.g., a clickstream) is a conforming or nonconforming use of the particular browser 50 generating the DNS requests.

The privacy agent 14 beneficially institutes browser controls based on the conformance determination 574, for example disabling use on the computing device 12 of a particular browser 50 corresponding to a particular browser user classifier 520 responsive to a user executing the particular browser 50. The privacy agent 14 can institute the browser controls without user intervention. Alternatively, the privacy agent 14 can request user input prior to instituting browser controls. Referring to FIG. 12D, the privacy agent 14 generates a fourth exemplary interactive display 180 via the user interface 56 of the computing device 12 responsive to a user attempting access via a particular browser 50 to a particular URL (“abcxyz.com”) or a stream of URLs including the particular URL. The fourth exemplary interactive display 180 includes a fourth notice 182 which reads “ABCXYZ.com is associated with personal activity. You don't usually use current browser for personal activity. Do you want to exit and switch to your preferred browser for personal activity, just exit current browser, or continue to use current browser?” The fourth notice 182 includes a “switch to preferred browser” button 184 to close the current browser and reopen the particular URL in a browser corresponding to a browser use classifier 520 for which the conformance determination 574 is “conforming” based on the input or inputs determined by the network address classifier 500 based on the particular URL or stream of URLs. The fourth notice 182 also includes an “exit current browser” button 186 to exit out of the current browser. The fourth notice 182 further includes a “continue with current browser” button 188 to continue execution and use by the user of the current browser.

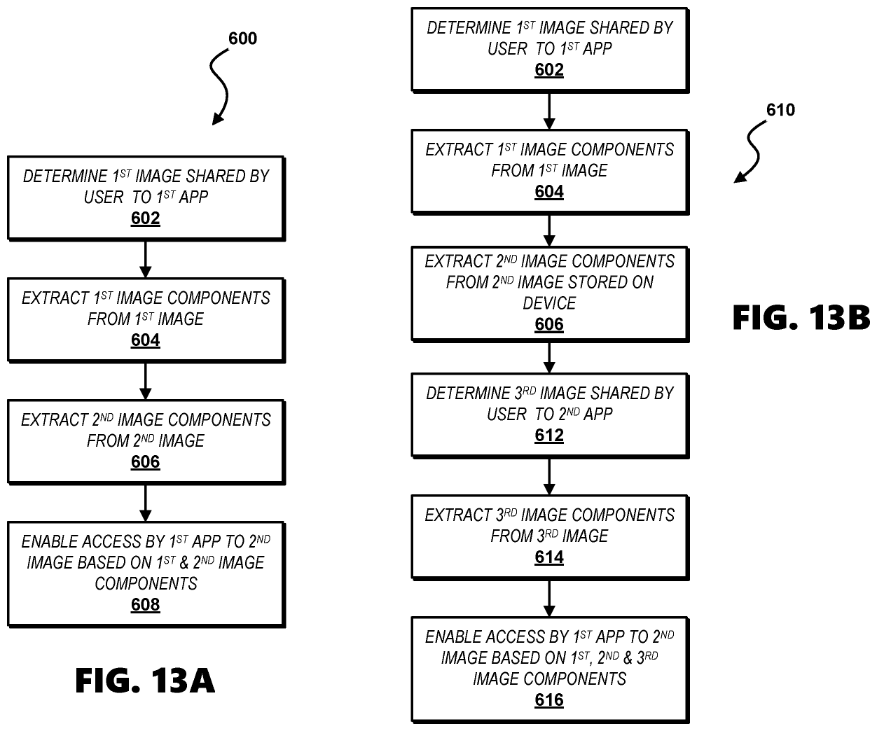

Referring to FIGS. 13A and 13B, methods for controlling electronic data sharing 600, 610 are shown. The methods 600, 610 are described with reference to the components of the system 10 shown in FIG. 1, including for example the computing device 12, the processor-enabled privacy manager 20, the privacy agent 14, and the network 8. Alternatively, the methods 600, 610 can be performed via other suitable systems and are not restricted to being implemented by the components of the system 10.

Referring particularly to FIG. 13A, in a step 602 of the method 600, a first image or a first plurality of images are determined to be shared by a user to a first network-enabled application beneficially via a computing device such as the computing device 12. The network-enabled application can include any application that provides for transmitting data via a network, for example a local application 52 in communication with web/app servers 40, a network-based application enabled by one or more web/app servers 40, or an application executed in a distributed network or peer-to-peer environment. In a step 604, a first plurality of image components are extracted from the first image or each of the first plurality of images. A second plurality of image components are extracted from a second image or a second plurality of images stored on the computing device of the user (step 606). Access by the first network-enabled application to the second image or the second plurality of images stored on the computing device of the user is enabled based on the first plurality of image components extracted from the first image or the first plurality of images and based on the second plurality of image components (step 608).

Referring to FIG. 13B, the method 610 includes the steps 602, 604, and 606 from FIG. 13A. In a step 612 a third image or a third plurality of images are determined to be shared by the user to the network-enabled application beneficially via the computing device. A third plurality of image components are extracted from the third image or each of the third plurality of images (step 614). Access by the first network-enabled application to the second image or the second plurality of images stored on the computing device of the user is enabled based on the first plurality of image components, the second plurality of image components, and the third plurality of image components (step 616). Access to an image stored on the computing device can alternatively be disabled. For example a fourth plurality of image components can be extracted from a fourth image or each of a fourth plurality of images stored on the computing device. Access by the first network-enabled application to the fourth image or the fourth plurality of images stored on the computing device of the user can be disabled based on the first plurality of image components, the third plurality of image components, and the fourth plurality of image components.

In the described methods 600, 610 the first plurality of image components can include a first plurality of topics, the second plurality of image components can include a second plurality of topics, and the third plurality of image components can include a third plurality of topics. A first classifier can be applied to extract the first plurality of image components from the first image or from each of the first plurality of images. A second classifier can be trained based on the first plurality of image components, and beneficially further based on the third plurality of image components. The first classifier can further be applied to extract the third plurality of image components from the third image or from each of the third plurality of images. The second classifier can be applied to classify the second image or the second plurality of images stored by the user on the computing device by applying the second classifier to the second plurality of image components, and the access by the first network-enabled application to the second image or the second plurality of images stored by the user on the computing device can be based on the classifying of the second image or the second plurality of images. The first classifier can include for example a convolutional neural network (“CNN”) classifier and the second classifier can include for example one or more of a k-nearest neighbors algorithm (“k-NN”) classifier, a support-vector machine (“SVM”) classifier, or decision tree classifier.

Beneficially, the first image is compared to the third image or each of the first plurality of images are compared to each of the third plurality of images to determine each first image is not the same as each third image. The second classifier can be trained based on the first plurality of image components as a first input of the second classifier and an indication that the first image or each of the first plurality of images are shared by the user to the first network-enabled application as a first output of the second classifier. The second classifier can further be trained based on the third plurality of image components as a second input of the second classifier and an indication that the third image or each of the third plurality of images are not shared by the user to the first network-enabled application as a second output of the second classifier.

Beneficially, a first vector representation or a first plurality of vector representations are generated for the first image or each of the first plurality of images based on the first plurality of image components, a second vector representation or a second plurality of vector representations are generated for the second image or each of the second plurality of images based on the second plurality of image components, a third vector representation or a third plurality of vector representations are generated for the third image or each of the third plurality of images based on the third plurality of image components. The second classifier is trained further based on the first vector representation and the third vector representation. Alternatively, in the absence of a third vector representation, a third plurality of vector representations, a third image or a third plurality of images, the second classifier can trained further based on the first vector representation without the third vector representation. The second classifier is applied to the second vector representation or each of the second plurality of vector representations to classify the second image or each of the second plurality of images.

In implementing the described methods 600, 610 further processes can include applying a facial recognition algorithm to one or more of the first plurality of images, the first plurality of image components, the second plurality of images, the second plurality of image components, the third plurality of images, or the third plurality of image components to determine a particular human. A frequency of occurrences of the particular human is determined in the one or more of the first plurality of images, the first plurality of image components, the second plurality of images, the second plurality of image components, the third plurality of images, or the third plurality of image components based on the applying of the facial recognition algorithm. The access by the first network-enabled application to the second plurality of images stored by the user on the computing device is enabled further based on the frequency of the occurrences of the particular human in one or more of the first plurality of images, the first plurality of image components, the second plurality of images, the second plurality of image components, the third plurality of images, or the third plurality of image components. More particularly, a first plurality of vector representations is generated for the first plurality of images based on the first plurality of image components and based on the determining the frequency of the occurrences of the particular human; a second plurality of vector representations is generated for the second plurality of images based on the second plurality of image components and based on the determining the frequency of the occurrences of the particular human; and a third plurality of vector representations is generated for the third plurality of images based on the third plurality of image components and based on the determining the frequency of the occurrences of the particular human. The second classifier is trained further based on the first plurality of vector representations and the third plurality of vector representations. The second classifier is applied to the second plurality of vector representations to classify one or more of the second plurality of images.

In implementing the described methods 600, 610 further processes can include generating a first plurality of scores for the first image or the first plurality of images based on the first plurality of image components, training the second classifier based on the first plurality of scores, generating a second plurality of scores for the second image or the second plurality of images based on the second plurality of image components, and applying the second classifier to the second plurality of scores to classify the second image or the second plurality of images.

In implementing the described methods 600, 610 further processes can include receiving a request from the first network-enabled application to access the second image or the second plurality of images or receiving a request from the user to grant access to the second image or the second plurality of images. The user can be queried via the computing device regarding the request from the first network-enabled application or the request from the user, and an instruction can be received from the user responsive to the querying, for example in the manner enabled by the first exemplary interactive display 120 of FIG. 12A. The access by the first network-enabled application to the second image or the second plurality of images stored by the user on the computing device can be enabled responsive to receiving the instruction and based on the first plurality of image components extracted from the first image or the first plurality of images.

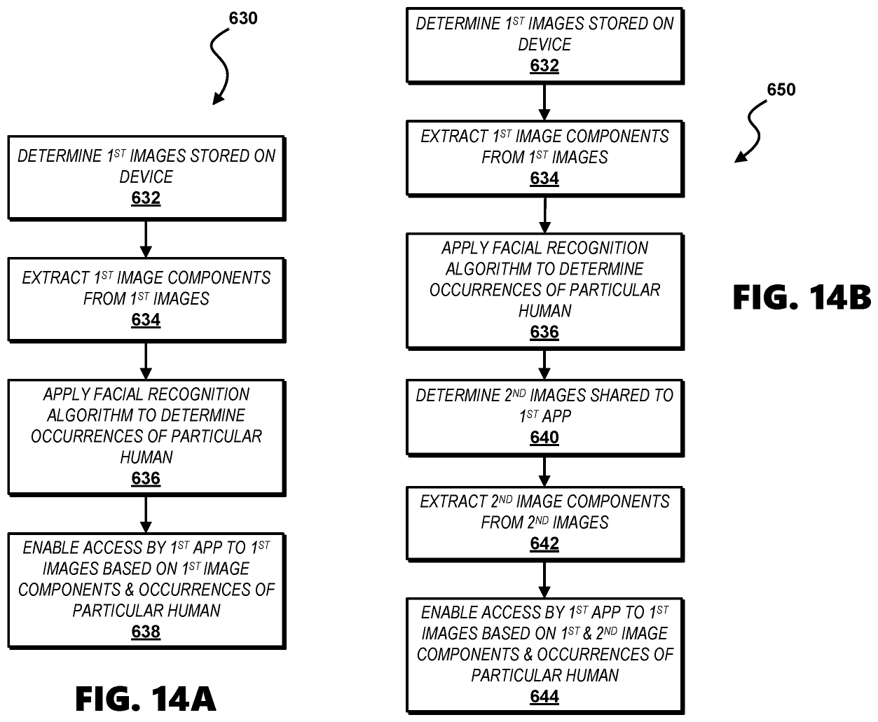

Referring to FIGS. 14A and 14B, methods for controlling electronic data sharing 630, 650 is shown. The methods 630, 650 are described with reference to the components of the system 10 shown in FIG. 1, including for example the computing device 12, the processor-enabled privacy manager 20, the privacy agent 14, and the network 8. Alternatively, the methods 630, 650 can be performed via other suitable systems and are not restricted to being implemented by the components of the system 10.

Referring particularly to FIG. 14A, in a step 632 of the method 630, a first plurality of images is determined to be stored by a user on a computing device, for example the computing device 12 of FIG. 1. A first plurality of image components are extracted from the first plurality of images (step 634). A facial recognition algorithm is applied to one or more of the first plurality of images or the first plurality of image components to determine a first plurality of occurrences of a particular human in the first plurality of images (step 636). Access by a first network-enabled application to the first plurality of images stored by the user on the computing device is enabled based on the first plurality of image components and the first plurality of occurrences of the particular human in the first plurality of images (step 638). Beneficially, a first classifier is applied to extract the first plurality of image components from the first plurality of images, a second classifier is applied to the first plurality of image components and the occurrences of the particular human in the first plurality of images to produce an output, and the access by the first network-enabled application to the first plurality of images stored by the user on the computing device is enabled based on the output of the second classifier.

Referring to FIG. 14B, the method 650 includes the steps 632, 634, and 636 from FIG. 14A. In a step 640 a second plurality of images shared by the user to the first network-enabled application are determined. A second plurality of image components are extracted from the second plurality of images (step 642). Access by a first network-enabled application to the first plurality of images stored by the user on the computing device is enabled based on the first plurality of image components, the second plurality of image components, and the first plurality of occurrences of the particular human in the first plurality of images (step 644).

In an extension of the method 650 a third plurality of images shared by the user to a second network-enabled application or additional applications can be determined, a third plurality of image components are extracted from the third plurality of images, and the access by the first network-enabled application to the first plurality of images stored by the user on the computing device is enabled further based on the third plurality of image components. Further, the facial recognition algorithm can be applied to one or more of the second plurality of images or the second plurality of image components and one or more of the third plurality of images or the third plurality of image components to determine a second plurality of occurrences of the particular human, and the access by the first network-enabled application to the first plurality of images stored by the user on the computing device can be enabled further based on the second plurality of occurrences of the particular human.

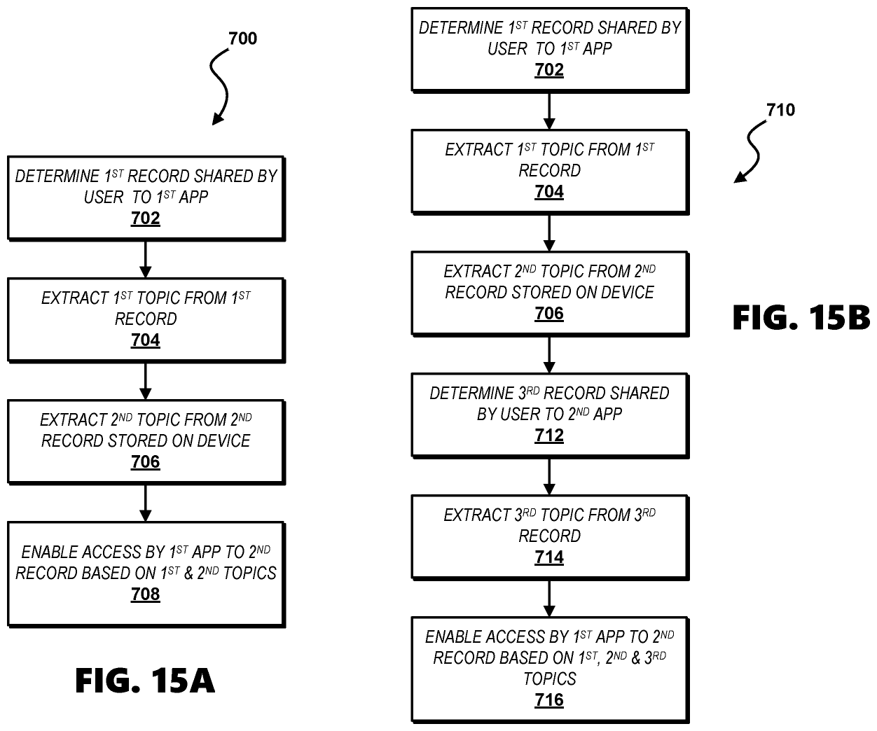

Referring to FIGS. 15A and 15B, methods for controlling electronic data sharing 700, 710 are shown. The methods 700, 710 are described with reference to the components of the system 10 shown in FIG. 1, including for example the computing device 12, the processor-enabled privacy manager 20, the privacy agent 14, and the network 8. Alternatively, the methods 700, 710 can be performed via other suitable systems and are not restricted to being implemented by the components of the system 10.

Referring particularly to FIG. 15A, in a step 702 of the method 700, a first electronic record or a first plurality of electronic records are determined to be shared by a user to a first network-enabled application beneficially via a computing device such as the computing device 12. A first topic or a first plurality of topics are extracted from the first electronic record or the first plurality of electronic records (step 704). A second topic or a second plurality of topics are extracted from a second electronic record or a second plurality of electronic records stored on a computing device of the user (step 706). Access by the first network-enabled application to the second electronic record or the second plurality of electronic records on the computing device of the user is enabled based on the first topic or the first plurality of topics and the second topic or the second plurality of topics (step 708).

Referring to FIG. 15B, the method 710 includes the steps 702, 704, and 706 from FIG. 15A. In a step 712, a third electronic record or a third plurality of electronic records are determined to be shared by a user to a second network-enabled application, beneficially via the computing device. A third topic or a third plurality of topics are extracted from the third electronic record or the third plurality of electronic records (step 714). Access by the first network-enabled application to the second electronic record or the second plurality of electronic records on the computing device of the user is enabled based on the first topic or the first plurality of topics and the second topic or the second plurality of topics and the third topic or the third plurality of topics (step 716).

In an extension of the method 710, the first topic or the first plurality of topics are equal to the second topic or the second plurality of topics, and the first topic or the first plurality of topics are not equal to the third topic or the third plurality of topics. And the method can further include extracting a fourth topic or a fourth plurality of topics from a fourth electronic record or a fourth plurality of electronic records stored on the computing device, and disabling access by the first network-enabled application to the fourth electronic record or the fourth plurality of electronic records based on the first topic or the first plurality of topics, the third topic or the third plurality of topics, and the fourth topic or the fourth plurality of topics.

Beneficially a first classifier is applied to extract the first topic or the first plurality of topics from the first electronic record or the first plurality of electronic records, and the first classifier is applied to extract the third topic or the third plurality of topics from the third electronic record or the third plurality of electronic records. A second classifier is trained based on the first topic or the first plurality of topics and based on the third topic or the third plurality of topics. The second classifier is applied to the second topic or the second plurality of topics to classify the second electronic record or the second plurality of electronic records stored by the user on the computing device, and the access by the first network-enabled application to the second electronic record or the second plurality of electronic records is enabled based on the classifying of the second electronic record or the second plurality of electronic records.

In implementing the described methods 700, 710 further processes can include receiving a request from the first network-enabled application to access the second electronic record or the second plurality of electronic records or receiving a request from the user to grant access to the second electronic record or the second plurality of electronic records. The user can be queried via the computing device regarding the request from the first network-enabled application or from the user, and an instruction can be received from the user responsive to the querying, for example in the manners enabled by the second and third exemplary interactive displays 140, 160 of FIGS. 12B and 12C. The access by the first network-enabled application to the second electronic record or the second plurality of electronic records stored by the user on the computing device can be enabled responsive to receiving the instruction and based on the first topic or the first plurality of topics extracted from the first electronic record or the first plurality of electronic records.

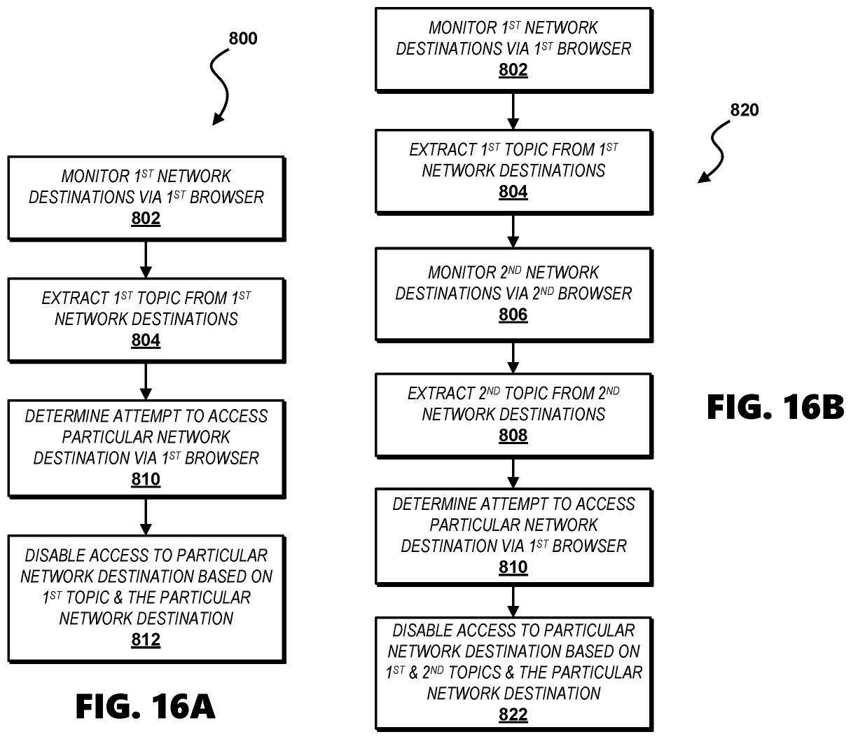

Referring to FIGS. 16A and 16B, methods for internet browsing control 800, 820 are shown. The methods 800, 820 are described with reference to the components of the system 10 shown in FIG. 1, including for example the computing device 12, the processor-enabled privacy manager 20, the privacy agent 14, and the network 8. Alternatively, the methods 800, 820 can be performed via other suitable systems and are not restricted to being implemented by the components of the system 10.

Referring particularly to FIG. 16A, the method 800 includes monitoring a first plurality of network destinations accessed by a user via a computing device such as the computing device 12 via a first browser application (step 802). A first topic or a first plurality of topics are extracted from the first plurality of network destinations (step 804). The topic includes a classification and need not be literal or human intelligible, for example a numeric or vector classification. An attempt to access a particular network destination by the user via the computing device via the first browser application is determined (step 810), and access by the user to the particular network destination via the computing device via the first browser application is disabled based on the first topic or the first plurality of topics extracted from the first plurality of network destinations and based on the particular network destination.

Referring to FIG. 16B, the method 820 includes the steps 802, 804, and 810 from FIG. 16A. The method 820 further includes monitoring a second plurality of network destinations accessed by the user via the computing device via a second browser application (step 806) and extracting a second topic or a second plurality of topics from the second plurality of network destinations (step 808). In a step 822, the access by the user to the particular network destination is disabled based on the first topic or the first plurality of topics and the second topic or the second plurality of topics and the particular network destination. Further, beneficially a third topic or third plurality of topics are extracted from the particular network destination and the access by the user to the particular network destination is disabled further based on the third topic or the third plurality of topics extracted from the particular network destination. Topics can be extracted via a classifier, for example via the exemplary network address classifier 500 of FIG. 10A. The access can be disabled for example based on output of the browser use classifier 520 of FIG. 11 as applied to the extracted topics. Alternatively, the particular network destination can be compared to one or both of the first plurality of network destinations or the second plurality of network destinations, and the access by the user to the particular network destination can be disabled further based on the comparing.

In an extension of the methods 800, 820, the user is queried regarding the attempt to access the particular network destination, an instruction is received from the user responsive to the querying, and the access by the user to the particular network destination via the computing device via the first browser application is disabled further based on receiving the instruction.

In a further extension of the methods 800, 820 a second plurality of network destinations accessed by the user via the computing device via a second browser application are monitored, and a second topic or a second plurality of topics are extracted from the second plurality of network destinations. An attempt to access the particular network destination by the user via the computing device via the second browser application is determined, and access by the user to the particular network destination via the computing device via the second browser application is enabled based on the second topic or the second plurality of topics extracted from the second plurality of network destinations and based on the particular network destination. Topics can be extracted via a classifier, for example via the exemplary network address classifier 500 of FIG. 10A, and the access can be enabled for example based on output of the browser use classifier 520 of FIG. 11 as applied to the extracted topics.

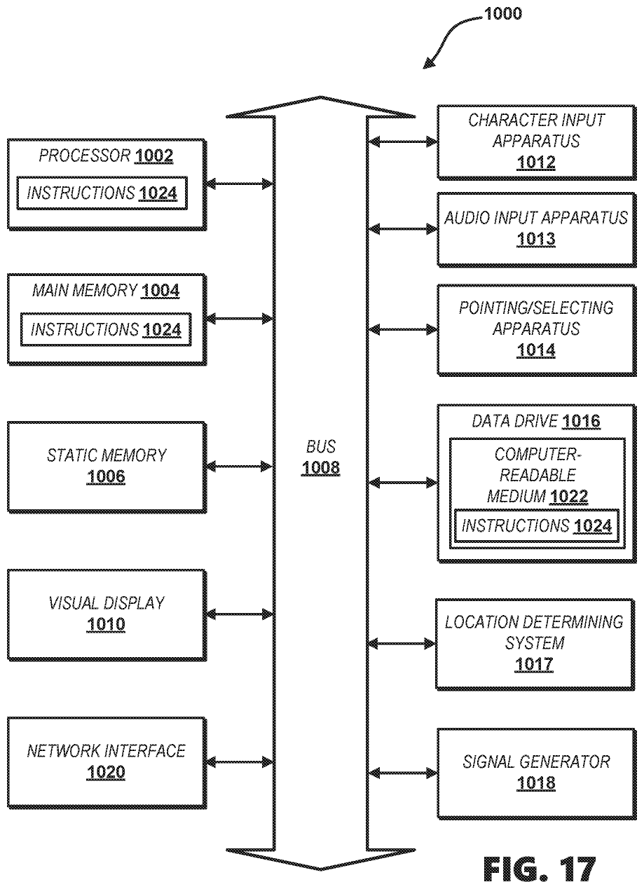

FIG. 17 illustrates in abstract the function of an exemplary computer system 1000 on which the systems, methods and processes described herein can execute. For example, the computing device 12, privacy manager 20, web/app servers 40, and application settings API 44 can each be embodied by a particular computer system 1000. The computer system 1000 may be provided in the form of a personal computer, laptop, handheld mobile communication device, mainframe, distributed computing system, or other suitable configuration. Illustrative subject matter is in some instances described herein as computer-executable instructions, for example in the form of program modules, which program modules can include programs, routines, objects, data structures, components, or architecture configured to perform particular tasks or implement particular abstract data types. The computer-executable instructions are represented for example by instructions 1024 executable by the computer system 1000.

The computer system 1000 can operate as a standalone device or can be connected (e.g., networked) to other machines. In a networked deployment, the computer system 1000 may operate in the capacity of a server or a client machine in server-client network environment, or as a peer machine in a peer-to-peer (or distributed) network environment. The computer system 1000 can also be considered to include a collection of machines that individually or jointly execute a set (or multiple sets) of instructions to perform one or more of the methodologies described herein.

It would be understood by those skilled in the art that other computer systems including but not limited to networkable personal computers, minicomputers, mainframe computers, handheld mobile communication devices, multiprocessor systems, microprocessor-based or programmable electronics, and smart phones could be used to enable the systems, methods and processes described herein. Such computer systems can moreover be configured as distributed computer environments where program modules are enabled and tasks are performed by processing devices linked through a communications network, and in which program modules can be located in both local and remote memory storage devices.

The exemplary computer system 1000 includes a processor 1002, for example a central processing unit (CPU) or a graphics processing unit (GPU), a main memory 1004, and a static memory 1006 in communication via a bus 1008. A visual display 1010 for example a liquid crystal display (LCD), light emitting diode (LED) display or a cathode ray tube (CRT) is provided for displaying data to a user of the computer system 1000. The visual display 1010 can be enabled to receive data input from a user for example via a resistive or capacitive touch screen. A character input apparatus 1012 can be provided for example in the form of a physical keyboard, or alternatively, a program module which enables a user-interactive simulated keyboard on the visual display 1010 and actuatable for example using a resistive or capacitive touchscreen. An audio input apparatus 1013, for example a microphone, enables audible language input which can be converted to textual input by the processor 1002 via the instructions 1024. A pointing/selecting apparatus 1014 can be provided, for example in the form of a computer mouse or enabled via a resistive or capacitive touch screen in the visual display 1010. A data drive 1016, a signal generator 1018 such as an audio speaker, and a network interface 1020 can also be provided. A location determining system 1017 is also provided which can include for example a GPS receiver and supporting hardware.

The instructions 1024 and data structures embodying or used by the herein-described systems, methods, and processes, for example software instructions, are stored on a computer-readable medium 1022 and are accessible via the data drive 1016. Further, the instructions 1024 can completely or partially reside for a particular time period in the main memory 1004 or within the processor 1002 when the instructions 1024 are executed. The main memory 1004 and the processor 1002 are also as such considered computer-readable media.

While the computer-readable medium 1022 is shown as a single medium, the computer-readable medium 1022 can be considered to include a single medium or multiple media, for example in a centralized or distributed database, or associated caches and servers, that store the instructions 1024. The computer-readable medium 1022 can be considered to include any tangible medium that can store, encode, or carry instructions for execution by a machine and that cause the machine to perform any one or more of the methodologies described herein, or that can store, encode, or carry data structures used by or associated with such instructions. Further, the term “computer-readable storage medium” can be considered to include, but is not limited to, solid-state memories and optical and magnetic media that can store information in a non-transitory manner. Computer-readable media can for example include non-volatile memory such as semiconductor memory devices (e.g., magnetic disks such as internal hard disks and removable disks, magneto-optical disks, CD-ROM and DVD-ROM disks, Erasable Programmable Read-Only Memory (EPROM), Electrically Erasable Programmable Read-Only Memory (EEPROM), and flash memory devices).

The instructions 1024 can be transmitted or received over a communications network, for example the communications network 8, using a signal transmission medium via the network interface 1020 operating under one or more known transfer protocols, for example FTP, HTTP, or HTTPs. Examples of communication networks include a local area network (LAN), a wide area network (WAN), the internet, mobile telephone networks, Plain Old Telephone (POTS) networks, and wireless data networks, for example Wi-Fi™ and 3G/4G/5G cellular networks. The term “computer-readable signal medium” can be considered to include any transitory intangible medium that is capable of storing, encoding, or carrying instructions for execution by a machine, and includes digital or analog communications signals or other intangible medium to facilitate communication of such instructions.

Although features and elements are described above in particular. combinations, one of ordinary skill in the art will appreciate that each feature or element can be used alone or in any combination with the other features and elements. Methods described herein may be implemented in a computer program, software, or firmware incorporated in a computer-readable medium for execution by a computer or processor.

While embodiments have been described in detail above, these embodiments are non-limiting and should be considered as merely exemplary. Modifications and extensions may be developed, and all such modifications are deemed to be within the scope defined by the appended claims.

What is claimed is:

1. A method for controlling electronic data sharing, the method comprising:
determining at least a first image shared by a user to a first network-enabled application;
extracting a first plurality of image components from the at least the first image; and
enabling access by the first network-enabled application to at least a second image stored on a computing device of the user based on the first plurality of image components extracted from the at least the first image.

2. The method of claim 1, the method further comprising:
extracting a second plurality of image components from the at least the second image;
determining at least a third image shared by the user to a second network-enabled application;
extracting a third plurality of image components from the at least the third image; and
enabling the access by the first network-enabled application to the at least the second image stored on the computing device further based on the second plurality of image components extracted from the at least the second image and the third plurality of image components extracted from the at least the third image.

3. The method of claim 2, further comprising:
extracting a fourth plurality of image components from at least a fourth image stored on the computing device; and
disabling access by the first network-enabled application to the at least the fourth image stored on the computing device based on the first plurality of image components extracted from the at least the first image, based on the third plurality of image components extracted from the at least the third image, and based on the fourth plurality of image components extracted from the at least the fourth image.

4. The method of claim 2, the first plurality of image components comprising a first plurality of topics, the second plurality of image components comprising a second plurality of topics, and the third plurality of image components comprising a third plurality of topics.

5. The method of claim 2, the at least the first image comprising a first plurality of images, the at least the second image comprising a second plurality of images, the at least the third image comprising a third plurality of images.

6. The method of claim 1, further comprising:
applying a first classifier to extract the first plurality of image components from the at least the first image;
training a second classifier based on the first plurality of image components from the at least the first image;
applying the second classifier to classify the at least the second image stored by the user on the computing device; and
enabling the access by the first network-enabled application to the at least the second image stored by the user on the computing device based on the classifying of the at least the second image.

7. The method of claim 6, the first classifier comprising a convolutional neural network (“CNN”) classifier and the second classifier comprising at least one of a k-nearest neighbors algorithm (“k-NN”) classifier, a support-vector machine (“SVM”) classifier, or decision tree classifier.

8. The method of claim 6, further comprising:
extracting a second plurality of image components from the at least the second image; and
applying the second classifier to the second plurality of image components to classify the at least the second image.

9. The method of claim 8, further comprising:
determining at least a third image shared by the user to a second network-enabled application;
extracting a third plurality of image components from the at least the third image; and
training the second classifier further based on the third plurality of image components from the at least the third image.

10. The method of claim 9, further comprising:
applying the first classifier to extract the second plurality of image components from the at least the second image; and
applying the first classifier to extract the third plurality of image components from the at least the third image.

11. The method of claim 9, further comprising:
comparing the at least the first image and the at least the third image to determine the at least the third image is not the same as the at least the first image; and
training the second classifier further based on the first plurality of image components as a first input of the second classifier and an indication that the at least the first image is shared by the user to the first network-enabled application as a first output of the second classifier; and
training the second classifier further based on the third plurality of image components as a second input of the second classifier and an indication that the at least the third image is not shared by the user to the first network-enabled application as a second output of the second classifier.

12. The method of claim 11, further comprising:
generating a first vector representation for the at least the first image based on the first plurality of image components;
generating a second vector representation for the at least the second image based on the second plurality of image components;
generating a third vector representation for the at least the third image based on the third plurality of image components;
training the second classifier further based on the first vector representation and the third vector representation; and
applying the second classifier to the second vector representation to classify the at least the second image.

13. The method of claim 11, further comprising:
the at least the first image comprising a first plurality of images, the at least the second image comprising a second plurality of images, the at least the third image comprising a third plurality of images, the method further comprising:
applying a facial recognition algorithm to at least one of the first plurality of images, the first plurality of image components, the second plurality of images, the second plurality of image components, the third plurality of images, or the third plurality of image components to determine a particular human;
determine a frequency of occurrences of the particular human in the at least one of the first plurality of images, the first plurality of image components, the second plurality of images, the second plurality of image components, the third plurality of images, or the third plurality of image components based on the applying of the facial recognition algorithm;
generating a first plurality of vector representations for the first plurality of images based on the first plurality of image components and based on the determining the frequency of the occurrences of the particular human;
generating a second plurality of vector representations for the second plurality of images based on the second plurality of image components and based on the determining the frequency of the occurrences of the particular human;
generating a third plurality of vector representations for the third plurality of images based on the third plurality of image components and based on the determining the frequency of the occurrences of the particular human;
training the second classifier further based on the first plurality of vector representations and the third plurality of vector representations; and
applying the second classifier to the second plurality of vector representations to classify the at least the second image.

14. The method of claim 11, further comprising:
the at least the first image comprising a first plurality of images, the at least the second image comprising a second plurality of images, the at least the third image comprising a third plurality of images, the method further comprising:
applying a facial recognition algorithm to at least one of the first plurality of images, the first plurality of image components, the second plurality of images, the second plurality of image components, the third plurality of images, or the third plurality of image components to determine a particular human;
determine a frequency of occurrences of the particular human in the at least one of the first plurality of images, the first plurality of image components, the second plurality of images, the second plurality of image components, the third plurality of images, or the third plurality of image components based on the applying of the facial recognition algorithm; and
enabling the access by the first network-enabled application to the second plurality of images stored by the user on the computing device further based on the frequency of the occurrences of the particular human.

15. The method of claim 11, further comprising:
the at least the first image comprising a first plurality of images, the at least the second image comprising a second plurality of images, the at least the third image comprising a third plurality of images, the method further comprising:
applying a feature recognition algorithm to at least one of the first plurality of images, the first plurality of image components, the second plurality of images, the second plurality of image components, the third plurality of images, or the third plurality of image components to determine a particular feature;
determine a frequency of occurrences of the particular feature in the at least one of the first plurality of images, the first plurality of image components, the second plurality of images, the second plurality of image components, the third plurality of images, or the third plurality of image components based on the applying of the feature recognition algorithm; and
enabling the access by the first network-enabled application to the second plurality of images stored by the user on the computing device further based on the frequency of the occurrences of the particular feature.

16. The method of claim 15, the particular feature comprising a location.

17. The method of claim 15, the particular feature comprising a pet.

18. The method of claim 9, further comprising:
the at least the second image comprising a second plurality of images, the method further comprising:
applying a facial recognition algorithm to the second plurality of images or the second plurality of image components to determine a particular human in the second plurality of images;
determine a frequency of occurrences of the particular human in the second plurality of images based on the applying of the facial recognition algorithm; and
enabling the access by the first network-enabled application to the second plurality of images stored by the user on the computing device further based on the frequency of the occurrences of the particular human in the second plurality of images.

19. The method of claim 9, the at least the first image comprising a first plurality of images, the at least the second image comprising a second plurality of images, the at least the third image comprising a third plurality of images, the method further comprising:
generating a first vector representation for each of the first plurality of images based on the first plurality of image components;
generating a second vector representation for each of the second plurality of images based on the second plurality of image components;
generating a third vector representation for each of the third plurality of images based on the third plurality of image components;
training the second classifier further based on the first vector representation and the third vector representation; and
applying the second classifier to the second vector representation to classify the second plurality of images.

20. The method of claim 8, further comprising:
generating a first plurality of scores for the at least the first image based on the first plurality of image components;
training the second classifier based on the first plurality of scores;
generating a second plurality of scores for the at least the second image based on the second plurality of image components; and
applying the second classifier to the second plurality of scores to classify the at least the second image.

21. The method of claim 8, further comprising:
generating a first vector representation for the at least the first image based on the first plurality of image components;
training the second classifier based on the first vector representation;
generating a second vector representation for the at least the second image based on the second plurality of image components; and
applying the second classifier to the second vector representation to classify the at least the second image.

22. The method of claim 1, the at least the second image comprising a second plurality of images comprising a second plurality of image components, the method further comprising:
applying a facial recognition algorithm to at least one of the second plurality of images or the second plurality of image components to determine a particular human in the second plurality of images;
determine a frequency of occurrences of the particular human in the second plurality of images based on the applying of the facial recognition algorithm; and
enabling the access by the first network-enabled application to the second plurality of images stored by the user on the computing device further based on the frequency of the occurrences of the particular human in the second plurality of images.

23. The method of claim 1, the at least the first image comprising a first plurality of images, the method further comprising:
applying a facial recognition algorithm to at least one of the first plurality of images or the first plurality of image components to determine a particular human in the first plurality of images;
determine a frequency of occurrences of the particular human in the first plurality of images based on the applying of the facial recognition algorithm; and
enabling the access by the first network-enabled application to the at least the second image stored by the user on the computing device further based on the frequency of the occurrences of the particular human in the first plurality of images.

24. The method of claim 1, further comprising:
receiving a request from the first network-enabled application to access a plurality of images comprising the at least the second image;
querying the user regarding the request from the first network-enabled application via the computing device;
receiving an instruction from the user responsive to the querying; and
enabling the access by the first network-enabled application to the at least the second image stored by the user on the computing device responsive to receiving the instruction and based on the first plurality of image components extracted from the at least the first image.

25. The method of claim 1, further comprising:
receiving a request from the user to grant access to a plurality of images comprising the at least the second image;
querying the user regarding the request from the user via the computing device;
receiving an instruction from the user responsive to the querying; and
enabling the access by the first network-enabled application to the at least the second image stored by the user on the computing device responsive to receiving the instruction and based on the first plurality of image components extracted from the at least the first image.

26. The method of claim 1, further comprising:
extracting a second plurality of image components from the at least the second image; and
enabling the access by the first network-enabled application to the at least the second image stored on the computing device of the user further based on the second plurality of image components extracted from the at least the second image.

27. The method of claim 1, wherein determining the at least the first image shared by the user to the first network-enabled application comprises determining the at least the first image shared by the user to the first network-enabled application via the computing device.

28. A method for controlling electronic data sharing, the method comprising:
determining a first plurality of images stored by a user on a computing device;
extracting a first plurality of image components from the first plurality of images;
applying a feature recognition algorithm to at least one of the first plurality of images or the first plurality of image components to determine a first plurality of occurrences of a particular feature in the first plurality of images; and
enabling access by a first network-enabled application to the first plurality of images stored by the user on the computing device based on the first plurality of image components and the first plurality of occurrences of the particular feature in the first plurality of images.

29. The method of claim 28, the feature recognition algorithm comprising a facial recognition algorithm, and the particular feature comprising a particular human.

30. The method of claim 29, further comprising:
applying a first classifier to extract the first plurality of image components from the first plurality of images;
applying a second classifier to the first plurality of image components and the occurrences of the particular human in the first plurality of images to produce an output; and
enabling the access by the first network-enabled application to the first plurality of images stored by the user on the computing device based on the output of the second classifier.

31. The method of claim 29, further comprising:
determining a second plurality of images shared by the user to the first network-enabled application;
extracting a second plurality of image components from the second plurality of images; and
enabling the access by the first network-enabled application to the first plurality of images stored by the user on the computing device further based on the second plurality of image components from the second plurality of images.

32. The method of claim 31, further comprising:
determining a third plurality of images shared by the user to at least a second network-enabled application;
extracting a third plurality of image components from the third plurality of images; and
enabling the access by the first network-enabled application to the first plurality of images stored by the user on the computing device further based on the third plurality of image components from the third plurality of images.

33. The method of claim 32, further comprising:
applying the facial recognition algorithm to at least one of the second plurality of images or the second plurality of image components and at least one of the third plurality of images or the third plurality of image components to determine a second plurality of occurrences of the particular human; and
enabling the access by the first network-enabled application to the first plurality of images stored by the user on the computing device further based on the second plurality of occurrences of the particular human.

34. A method for controlling electronic data sharing, the method comprising:
determining at least a first electronic record shared by a user to a first network-enabled application;
extracting at least a first topic from the at least the first electronic record; and
enabling access by the first network-enabled application to at least a second electronic record on a computing device of the user based on the at least the first topic extracted from the at least the at least the first electronic record.

35. The method of claim 34, the method further comprising:
extracting at least a second topic from the at least the second electronic record;
determining at least a third electronic record shared by the user to a second network-enabled application;
extracting at least a third topic from the at least the third electronic record; and
enabling the access by the first network-enabled application to the at least the second electronic record stored by the user on the computing device further based on the at least the second topic extracted from the at least the second electronic record and the at least the third topic extracted from the at least the third electronic record.

36. The method of claim 35, the at least the first electronic record comprising a first plurality of electronic records, the at least the second electronic record comprising a second plurality of electronic records, the at least the third electronic record comprising a third plurality of electronic record.

37. The method of claim 35, wherein the at least the first topic is equal to the at least the second topic, and the at least the first topic is unequal to the at least the third topic, the method further comprising:
extracting at least a fourth topic from at least a fourth electronic record stored on the computing device; and
disabling access by the first network-enabled application to the at least the fourth electronic record on the computing device based on the at least the first topic extracted from the at least the first electronic record, the at least the third topic extracted from the at least the third electronic record, and the at least the fourth topic extracted from the at least the fourth electronic record.

38. The method of claim 34, further comprising:
extracting a first plurality of topics comprising the at least the first topic from the at least the first electronic record;
extracting a second plurality of topics from the at least the second electronic record;
determining at least a third electronic record shared by the user to a second network-enabled application;
extracting a third plurality of topics from the at least the third electronic record;
applying a first classifier to extract the first plurality of topics from the at least the first electronic record;
training a second classifier based on the first plurality of topics from the at least the first electronic record and based on the third plurality of topics from the at least the third electronic record;
applying the second classifier to the second plurality of topics to classify the at least the second electronic record stored by the user on the computing device; and
enabling the access by the first network-enabled application to the at least the second electronic record stored by the user on the computing device based on the classifying of the at least the second electronic record.

39. The method of claim 34, further comprising:
receiving a request from the first network-enabled application to access a plurality of electronic records comprising the at least the second electronic record;
querying the user regarding the request from the first network-enabled application via the computing device;
receiving an instruction from the user responsive to the querying; and
enabling the access by the first network-enabled application to the at least the second electronic record stored by the user on the computing device responsive to receiving the instruction and based on the at least the first topic extracted from the at least the first electronic record.

40. An internet browsing control method, the method comprising:
monitoring a first plurality of network destinations accessed by a user via a computing device via a first browser application;
extracting at least a first topic from the first plurality of network destinations;
determining an attempt to access a particular network destination by the user via the computing device via the first browser application; and
disabling access by the user to the particular network destination via the computing device via the first browser application based on the at least the first topic extracted from the first plurality of network destinations and based on the particular network destination.

41. The internet browsing method of claim 40, further comprising:
monitoring a second plurality of network destinations accessed by the user via the computing device via a second browser application;
extracting at least a second topic from the second plurality of network destinations; and
disabling the access by the user to the particular network destination further based on the at least the second topic extracted from the second plurality of network destinations.

42. The internet browsing method of claim 41, further comprising:
extracting at least a third topic from the particular network destination; and
disabling the access by the user to the particular network destination further based on the at least the third topic extracted from the particular network destination.

43. The internet browsing method of claim 40, further comprising:
comparing the particular network destination to the first plurality of network destinations; and
disabling the access by the user to the particular network destination further based on the comparing.

44. The internet browsing method of claim 40, further comprising:
querying the user regarding the attempt to access the particular network destination by the user via the computing device via the first browser application;
receiving an instruction from the user responsive to the querying; and
disabling the access by the user to the particular network destination via the computing device via the first browser application further based on the receiving the instruction.

45. The internet browsing method of claim 40, further comprising:
monitoring a second plurality of network destinations accessed by the user via the computing device via a second browser application;
extracting at least a second topic from the at least the second plurality of network destinations;
determining an attempt to access the particular network destination by the user via the computing device via the second browser application; and
enabling access by the user to the particular network destination via the computing device via the second browser application based on the at least the second topic extracted from the second plurality of network destinations and based on the particular network destination.

46. The internet browsing method of claim 45, further comprising:
comparing the particular network destination to the second plurality of network destinations; and
enabling the access by the user to the particular network destination further based on the comparing.
